(19) United States
(12) Patent Application Publication
(10) Pub. No.: US 2020/0031728 A1
(43) Pub. Date: Jan. 30, 2020

(54) CONTROLLED RELEASE GRANULAR FERTILISER

(71) Applicant: COMMONWEALTH SCIENTIFIC AND INDUSTRIAL RESEARCH ORGANISATION, Australian Capital Territory (AU)

(72) Inventors: Raju ADHIKARI, Victoria (AU); Tim Harvey MUSTER, South Australia (AU); George FREISCHMIDT, Victoria (AU)

(73) Assignee: COMMONWEALTH SCIENTIFIC AND INDUSTRIAL RESEARCH ORGANISATION, Australian Capital Territory (AU)

(21) Appl. No.: 16/337,608

(22) PCT Filed: Sep. 28, 2017
(86) PCT No.: PCT/AU2017/051066

§ 371 Date: Mar. 28, 2019

(30) Foreign Application Priority Data
Sep. 29, 2016 (AU) 2016903964

(51) Int. Cl. C05C 1/02; C05C 3/00; C05C 9/00; C05G 3/00

(52) U.S. Cl. CPC C05C 1/02; C05C 3/005; C05G 3/0029; C05G 3/0052; C05C 9/005

(57) ABSTRACT

A controlled release granular fertiliser composition comprising a mixture of nitrogenous fertiliser, particulate silicate mineral filler and biodegradable ionic polyurethane.

### FIELD

The invention relates to a controlled release granular fertiliser and to a process far preparation of the granular fertiliser and its use.

### BACKGROUND OF INVENTION

It is known to coat agricultural chemicals (“agrichemicals”), such a fertilizers, soil conditioners, fungicides, insecticides, herbicides, nematocides, plant hormones, insect repellents, and the like, in order to control their release over varying periods of time after they have been applied.

It is well known that crops in the early stages of development are harmed by heavy doses of fertilizer. Furthermore, when agrichemicals, particularly water soluble agrichemicals, are applied to open fields, some of the fertilizer is washed into the local drainage system by rainwater runoff. This portion of the fertilizer is ineffective for its intended use and can significantly pollute nearby waterways and reservoirs.

Controlled release products have been prepared which attempt to deliver agrichemicals to plants at a time period in their development when the agrichemicals provide the most desirable benefits. To a large extent, these products are made by coating fertilizer granules or grills with various materials to reduce the rate of release of the fertilizing agent.

U.S. Pat. No. 3,223,518 issued to Hansen Dec. 14, 1965 discloses coatings of polymer resins exemplified by linseed oil- or soybean oil-based resins, e.g. linseed oil-based copolymers with dicyclopentadiene. The release rates of the coated products described in the '518 patent depend on various factors, some of which include the number of coatings applied to the product, or the coating's thicknesses, and the type of polymer used in the coating. In such fertilisers the onset of release occurs almost immediately upon application of the fertilizer product and typically within a week of being applied. A fertilizer product exemplifying this type of controlled release is available as Osmocote® fertilizer. Water-insolubility of the coating resin, such as polyethylene, polypropylene and copolymers thereof have been investigated. U.S. Pat. No. 4,369,055 describes fertilizer with a controlled permeability coating comprises a polyolefin coating which is prepared by spraying a hot solution of polyolefin type resin, ethylene-vinyl acetate copolymer or vinylidene type resin upon fertilizer granules, and drying the fertilizer granules Such coatings will not disintegrate, and remains intact. Pores provided in the coating allow for a low, substantially constant release rate of delivery of the active. The onset of this release occurs upon application of the product. Commercially available fertilizers which employ the additive approach include NUTRICOTE® fertilizers available from Chisso-Asahi Fertilizer Co., Ltd.

In instances where it would be advantageous to increase the rate of fertilizer release after that initial period slow release products do not maximize delivery of fertilizer. In those instances it would be preferable to have a product for which the onset of agent release is delayed for the period of time necessary, but for which at a later, predetermined time substantial release begins.

EP0628527 discloses a delayed, controlled release product comprising: a core comprising a water soluble active ingredient; a first coating layer on the surface of the core, wherein the layer has the ability to release the active ingredient at a controlled rate; and a second coating layer encapsulating the first. Application of these coatings tends to require significant thicknesses to avoid breaches which can lead to rapid loss of the agrichemical or a number of different coatings to ensure maintenance of an effective barrier to agrichemical release for the required delay period.

There is a need for a granular fertiliser which reliably allows the release of fertiliser to be controlled as required to meet plant growth requirements.

### SUMMARY OF INVENTION

There is provided a controlled release granular fertiliser composition comprising a mixture of nitrogenous fertiliser, particulate silicate mineral filler and biodegradable ionic polyurethane.

In a preferred set of embodiments the ionic polyurethane comprises a plurality of ionic groups, such as those selected from the group consisting of carboxylate, sulfonate and ammonium and preferably derived from monomers independently selected from the group consisting of

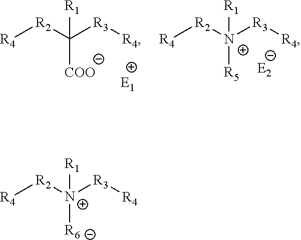

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, alkyl groups of 1 to 18 carbon atoms; aryl groups; aralkyl groups;
R₆ is selected from the group consisting of carboxylates, sulfonates and phosphorates.
E₁ is a counter-ion that is organic or inorganic; and
E₂ is a counter-ion that is organic or inorganic

In one set of embodiments the controlled release granular fertiliser composition further comprises a coating of a barrier material about granules of the composition.

In one set of embodiments the barrier material is selected from the group consisting of biodegradable polyesters.

In a further aspect there is provided a granular fertiliser composition for delayed release of the fertiliser, the granules comprising an extruded coating of biodegradable polyester polymer and a core matrix comprising a mixture of a nitrogenous fertiliser and a silicate mineral.

In one set of embodiments the granular fertiliser is an intimate mixture comprising:
from 20% to 70% w/w (preferably 30% to 65% w/w) of nitrogenous fertiliser:
from 10% to 60% w/w (preferably 10% to 30% w/w) of silicate mineral; and
from 5% to 60% w/w (preferably 10% to 30% w/w) biodegradable polyurethane;
   wherein the weights are based on dry weight t the mixture composition.

In a further set of embodiments there is provided a process for preparing a granular fertiliser composition comprising:
forming an aqueous mixture comprising nitrogenous'fertiliser, silicate mineral and ionic biodegradable ionic polyurethane; and
granulating the aqueous composition to provide granules of nitrogenous fertiliser.

### DETAILED DESCRIPTION

The granules of the composition include a fertiliser. The term “fertiliser” refers to material of natural or synthetic origin (other than liming materials) that is applied to soils to supply one or more plant nutrients essential to the growth of plants. The fertiliser may provide a source of one or more of nitrogen, phosphorus, potassium, calcium, magnesium and sulfur. Specific examples of fertilisers may be selected from the group consisting of urea, ammonium nitrate, potassium nitrate, ammonium sulfate, potassium sulfate, potassium chloride, mono ammonium phosphate (MAP), diammonium phosphate (DAP) and mixtures of two or more thereof. Fertilisers providing at least one or more of nitrogen, phosphorus and potassium are preferred and nitrogen based fertilisers are particularly useful in the granular composition, optionally in combination with one or more of phosphorus, potassium, calcium, magnesium and sulfur. The more preferred nitrogen based fertilisers are urea and nitrates such as calcium nitrate and ammonium nitrate. Fertilisers based on urea optionally in combination with a nitrate such as ammonium nitrate and or calcium nitrate are particularly preferred.

The terms “agrichemical” and “agrichemicals”, refer to a wide range of active materials used in agriculture such a fertilizers, soil conditioners, fungicides, insecticides, herbicides, nematocides, plant hormones, insect repellents, and the like.

Where used herein the term molecular weight (Mn) or Mn refers to the number average molecular weight and the term molecular weight (Mp) or Mp refers to the mode of the molecular weight distribution or molecular weight of the highest peak.

The term “plants” refers to all physical parts of plants including seeds, seedlings, saplings, roots, tubes and material from which plants may be propagated.

The term “soil” refers to the life-supporting upper surface of earth that is the basis of all agriculture. It contains minerals and gravel from the chemical and physical weathering of rocks, decaying organic matter (humus), microorganism, insects, nutrients, water, and air. Soils differ according to the climate, geological structure, and rainfall of the area and are constantly being formed, changed and removed by natural, animal, and human activity.

In the context of the present invention, the terms “granules” and “granular” includes capsules, pellets, pills or beads. As used herein, “pellet” means a rounded body (e.g. spherical, cylindrical). The terms pellets and granules are generally used interchangeably herein. Generally pellets and granules in accordance with the invention have a maximum dimension in the range of from 1 mm to 20 mm and more preferable from 1 mm to 20 mm, such as 1 to 8 mm, 3 mm to 20 mm or 5 mm to 20 mm. In one set of embodiments the pellets are cylindrical and have an aspect ratio (length to width) of from 1 to 10, preferably from 1 to 8.

The term “biodegradable” is art-recognized, and includes polymers, compositions and formulations, such as those described herein, that are intended to degrade during use by biological means such as bacteria and fungi in addition to degradation by other chemical processes such as hydrolytic, oxidative and enzymatic processes. Such use involves degradation to produce release of the active and regulate release of the active. In general, degradation attributable to biodegradability involves the degradation of a biodegradable polymer into its component sub units monomers and oligomers, and eventually into nontoxic by products.

The term “reactive extrusion” herein refers to the performance of chemical reactions during continuous extrusion of polymers and/or polymerizable monomers. The reactants are in a physical form suitable for extrusion processing. Reactions may be performed on molten polymers, on liquefied monomers, or on polymers dissolved or suspended in or plasticized by solvent. Reactive extrusion refers to the performance of chemical reactions in a continuous extrusion process with short residence times. Detailed teachings relating to reactive extrusion are, for example, provided in “Reactive Extrusion—Principles and Practice” edited by M. Xanthos, Carl Hanser Verlag, Munich, Vienna, New York, Barcelona, 1992.

In general, the term “Lewis acid”, as used herein, refers to a chemical species, other than a proton, that has a vacant orbital or accepts an electron pair. The Lewis acid may be an organometallic or inorganic Lewis acids.

Throughout the description and the claims of this specification the word “comprise” and variations of the word, such as “comprising” and “comprises” is not intended to exclude other additives, components, integers or steps.

In the most preferred embodiment the fertiliser comprises a nitrogenous fertilizer such as urea, ammonium nitrate, calcium nitrate or mixture thereof.

In one set of embodiments the fertiliser (preferably a nitrogenous fertiliser) is present in an amount of at least 30% by weight of the dry weight of the granular composition, preferably at least 35% by weight of the dry weight and most preferably at least 40% by weight of dry weight of the granular composition.

The granular composition further comprises a particulate silicate. Examples of silicates include attapulgite, kaolin, diatomaceous earth, bentonite, zeolite, mica, talc and mixtures thereof. The silicate is preferably a clay, more preferably selected from the group consisting of attapulgite, montmorillonite and bentonite. Bentonite is particularly preferred. The presence of silicate mineral allows greater control of release and in combination with an ionic polyurethane and fertiliser, particularly nitrogenous fertiliser, provides excellent delayed and controlled release propertied. Delayed release may be further controlled by use of a coating of biodegradable polymer.

More preferred fertiliser actives are water soluble nitrogenous fertiliser, most preferably urea, urea ammonium nitrate, urea calcium nitrate or mixture thereof. In some embodiments the fertiliser further comprises one or more further actives such as at least one of a potassium and phosphorus fertiliser component. In one embodiment the composition comprises nitrogenous, potassium and phosphorus fertiliser components providing a suitable NPK balanced fertiliser.

In a particularly preferred embodiment the granular fertiliser comprises a mixture of fertiliser composition comprising a urea, urea ammonium nitrate, urea calcium nitrate or mixture composition, a clay and a biodegradable ionic polyurethane. Generally the composition comprising the clays becomes extrudable when containing minimal amounts of water and thus allows the granules to be formed by extrusion optionally with a coating such as a coextruded polymeric coating. The granular fertiliser composition, in a preferred set of embodiments comprises a nitrogen fertiliser, particularly an aqueous liquid urea with a particulate silicate mineral such as a clay and an aqueous dispersion of biodegradable ionic polyurethane polymer.

The presence of the solid particulate silicate mineral, particularly a clay and dispersion of ionic polyurethane provides control over release of the fertiliser in the granular composition. The granules may be formed of a mixture of the components or in a further embodiment may comprise a coating about the mixture. We have found that the presence of a biodegradable ionic polyurethane polymer, optionally in combination with the polymer granule coating, provides a significant delay in release of the fertiliser once the product has been placed in contact with soil or moisture. The presence of a biodegradable ionic polyurethane polymer in the of granules allows delay in the commencement of release, particularly in embodiments in which granules comprise a biodegradable polymer coating about the matrix and the presence of ionic polyurethane also allows the rate of release to be controlled.

The granular fertiliser composition allows the release of fertiliser following placement of the granules to be delayed for a period, particularly where the granules further comprise a coating of biodegradable polymer, particularly an aliphatic polyester. This delay period is particularly advantageous where fertiliser is placed during placement of plants such as seed, seedlings or transplanted plants which have progressed beyond the seedling stage. In one set of embodiments the process provides pellets which have a period of delay of at least 7 days, preferably at least 14 days. The delay in commencement of release allows establishment of the plant prior to release and avoids the harm which results from heavy doses of fertilizer. Furthermore the composition prepared by the process allows the most economic use of fertiliser by allowing release to be controlled to provide a delay of the fertiliser release to a time when it is most productively used by plants to induce growth and/or crop production. This improvement r the economy with which fertiliser is used also has the significant ecological benefit of reducing the potential for fertilizer to be washed by irrigation or rain into the local drainage system as runoff.

In one set of embodiments the granule composition comprises an intimate mixture comprising:
from 20% to 70% (preferably 30% to 65% w/w) of nitrogenous fertiliser;
from 10% to 60% w/w (preferably 10% to 30% w/w)of silicate mineral; and
from 5% to 60% w/w (preferably 5% to 30% w/w) ionic polyurethane polymer, preferably biodegradable ionic polyurethane;
   wherein the weights are based on dry weight of the mixture composition.

The water content of the granular fertiliser in one set of embodiments is up to 40% by weight based on the granular fertiliser such as 20% to 40% by weight of the granular fertiliser.

The granular composition comprises a biodegradable ionic polyurethane polymer. The biodegradable ionic polyurethane polymer may be used in the form of an aqueous dispersion which is mixed with the fertiliser and particulate mineral silicate to form an aqueous slurry or paste of the composition (which may optionally be dried) and is granulated optionally with a coating material such as a polymeric coating.

In one set of embodiments the ionic polyurethane is of the type disclosed for use in forming membranes in International Publication WO 2015/184490.

In particular, it is preferred that the polyurethane comprise a biodegradable polyester polyol. The polyester polyols are esterification products prepared by the reaction of organic polycarboxylic acids or their anhydrides with a stoichiometric excess of a polyol. Examples of suitable polyols for use in the reaction include polylactic acid polyol, polyglycolic polyol, polyglycol adipates, polyethylene terepthalate polyols, polycaprolactone polyols, orthophthalic polyols, and sulfonated polyols, etc. The polycarboxylic acids and polyols are typically aliphatic or aromatic dibasic acids and dials. The diols used in making the polyester include alkylene glycols, e.g., ethylene glycol, butylene glycol, neopentyl glycol and other glycols such as bisphenol A, cyclohexane diol, cyclohexane dimethanol, caprolactone diol, hydroxyalkylated bisphenols, and polyether glycols. The biodegradable polyurethane, in one set of embodiments comprises one or more polyester monomer segment selected from the group consisting of polylactic acid, poly(glycolic acid), polycaprolactone, polyvalerolactone, poly(hydroxyl valerate), poly(ethylene succinate), polybutylene succinate), poly(butylenesuccinateadipate), poly(para-dioxanone), polydecalactone, poly(4-hydroxybutyrate), poly(beta-malic acid) and poly(hydroxyl valerate).

In the most preferred embodiment the polyurethane comprises a polyester segment selected from polycaprolactone, polylactic acid and a mixture thereof or copolymer thereof.

An aqueous dispersion of polyurethane for mixing with the other matrix components may be prepared by reacting a diisocyanate with an active hydrogen containing monomer such as dihydroxy polyol to form an isocyanate terminated prepolymer. The active hydrogen containing monomer may comprise of ionic or ionisable pendent groups or the isocyanate capped prepolymer may be reacted with a chain extender to provide ionic or ionisable groups. In one set of embodiments the prepolymer is chain extended with a polyol, polyamide, polyamine or mixture thereof which may comprise ionic or ionisable pendent groups. In one set of embodiments the prepolymer is chain extended with a primary or secondary amine having at least two active hydrogens and which may be quaternized to provide cationic groups.

Specific examples of suitable aliphatic polyisocyanates include those selected from the group consisting of hexamethylene 1,6-diisocyanate, 1,12-dodecane diisocyanate, 2,2,4- trimethyl-hexamethylene diisocyanate, 2,4,4-trimethyl-hexamethylene diisocyanate, 2-methyl-1,5-pentamethylene diisocyanate, alkyl-lysinediisocyanate (such as ethyl-lysine diisocyanate) and mixtures thereof. Specific examples of suitable cycloalipahtic polyisocyanates include dicyclohexlymethane diisocyanate, isophorone diisocyanate, 1,4-cyclohexane diisocyanate, 1,4-cyclohexane bis(methylene isocyanate), 1,3-bis(isocyanatomethyl) cyclohexane, and mixtures thereof. In general we have found isophorone diisocyanate or cyclohexane bis(methylene isocyanate), to be particularly useful in providing the desired properties of biodegradability and membrane formation properties to match the growing season of the crop.

In a particularly preferred set of embodiments the polyurethane is an ionic polyurethane comprising ionic groups selected from the group consisting of carboxylate, sulfonate and ammonium. Accordingly the matrix preferably comprises a polyurethane which is a reaction product of (a) a diisocyanate; and (b) at least one active hydrogen containing compound and wherein at least one active hydrogen containing compound comprises an ionic or ionisable group which provide ionic groups on neutralisation.

The polyurethane preferably comprises a polyol particularly a polyester polyol prepolymer which confers biodegradability ion the polyurethane and which has a molecular weight of 500-5000, preferably 500-2000.

In one set of of embodiments the polyurethane polymer is chain extended with a primary or secondary amine having at least two active hydrogens and which may be quaternised to provide cationic groups.

In a particularly preferred set of embodiments the polyurethane comprises a plurality of ionic groups derived from monomers independently selected from the group consisting of

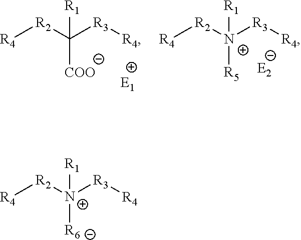

and mixtures thereof, where:
R₁ is an alkyl group of 1 to 4 carbons;
R₂ and R₃ are independently selected from the group consisting of alkyl groups of 1 to 4 carbon atoms; aryl; aralkyl: polyester and polyether moieties;
R₄ is —O or —NH, where the bond — denotes the point of attachment to the polymer backbone or terminal functional groups of the polymer;
R₅ is selected from the group consisting of hydrogen, alkyl groups of 1 to 18 carbon atoms; aryl groups; aralkyl groups;
R₆ is selected from the group consisting of carboxylates sulfonates and phosphonates.
E₁ is a counter-ion that is organic or inorganic; and
E₂ is a counter-ion that is organic or inorganic.

In this embodiment he ionic groups may, for example be provided by one or more monomers selected from the group consisting of 2,2-bis(hydroxymethyl) propionic acid (BMPA), tartaric acid, dimethylol butanoic acid (DMBA), glycollic acid, thioglycollic acid, lactic acid, malic acid, dihydroxy malic acid, dihydroxy tartaric acid, and 2,6-dihydroxy benzoic acid and neutralisation of the resulting polymer with a tertiary amine.

In the most preferred embodiment, the polyurethane comprises aliphatic polyester did segments such as polycaprolactone diol segments and a plurality of the ionic groups.

The controlled release granular fertiliser composition in one set of embodiments comprises a polyurethane which is cross linked by a cross linker selected from the group consisting of divalent and trivalent metal cations.

Ionic groups are preferably incorporated into the polyurethane to provide a stable water based dispersion. This allows the use of organic solvents to be minimised and assists in providing a resilient coating of the granule components. Examples of particularly preferred anionic ionisable compounds include 2,2-bis(hydroxymethyl) propionic acid (BMPA)—also known as dimethylol propanoic acid (DMPA), tartaric acid, dimethylol butanoic acid (DMBA), glycollic acid, thioglycollic acid, lactic acid, malic acid, dihydroxy malic acid, dihydroxy tartaric acid, and 2,6-dihydroxy benzoic acid.

The acid ionisable groups are generally incorporated in the polymer or prepolymer in an inactive form and activated by a salt-forming compound such as a tertiary amine. Neutralization of the polymer or prepolymer having dependent carboxyl groups with the tertiary amine converts the carboxyl groups to carboxylate anions, thus having a solubilizing effect. Suitable tertiary amines, which can be used to neutralize the polymer include organic tertiary amine bases such as triethyl amine (TEA), N-methyl morpholine and inorganic bases sodium hydroxide or ammonia. The preferred tertiary amine is triethyl amine (TEA). It is recognized that primary or secondary amines may be used in place of tertiary amines, if they are sufficiently hindered to avoid interfering with the chain extension process.

Aqueous dispersions of cationic polyurethane polymers may be prepared using chain extenders which comprise of secondary amines. For instance an N-alkyl dialkanolamine such as N-methyl diethanolamine (MDEA) may be used as a chain extender and then the product quatemised by reacting with a quaternising agent. Cationic polyurethanes may also be prepared having tertiary amine groups tethered to the polyurethane backbone. Such cationic polyurethanes may be prepared from polyols substituted with side chains comprising a tertiary amine group which may be quatemised and neutralised with an organic acid such as formic acid, acetic acid, propionic acid, succinic acid, glutaric acid, butyric acid, lactic acid, malic acid, citric acid, tartaric acid, malonic acid and adipic acid; organic sulfonic acids such as sulfonic acid, paratoluene sulfonic acid and methanesulfonic acid; inorganic acids such as hydrochloric acid, sulfuric acid, nitric acid, phosphoric acid, boric acid, phosphorous acid and fluoric acid. Examples of polyurethanes having tethered cationic groups are disclosed in WO2012/058534, US2008/0090949, and US2005/0112203, EP application No. 92309879.2, US 2013/0316098 and U.S. Pat. No. 5,561,187

If desired chain extension may be achieved using one or more polyamines. Organic compounds having two or more primary and/or secondary amine groups may be used. Suitable organic amines for use as a chain extender include di-ethylene tri-amine (DETA), ethylene diamine (EDA), meta-xylylene diamine (MXDA), and aminoethyl ethanolamine (AEEA). Also suitable for practice in the present invention are propylene diamine, butylene diamine, hexamethylene diamine, cyclahexylene diamine, phenylene diamine, tolylene diamine, xylene diamine, 3,3-dichlorobenzidene, 4,4-methylene-bis (2-chloroaniline), and 3,3-dichloro-4,4-diamino diphenylmethane.

The weight (dry weight basis) ratio of silicate mineral to nitrogenous fertiliser is preferably in the range of from 1:5 to 5:1, more preferably 1:2 to 1:1.

The granular fertiliser may, if desired additionally contain a further agrichemical such as one or more of herbicides, insecticides and fungicides, and plant growth regulators.

The granules of granular fertiliser composition may be formed by any of a range of methods known in the art for granulation. The granules may be formed by wet granulation, for example by application of the dispersion of ionic polyurethane to a composition of active fertiliser component and particulate silicate mineral. Alternatively a dry granulation process such as tableting may be used. In one set of embodiments the granules are formed by extrusion. The granules may comprise a coating which may also be applied by applying the coating as a wet spray a melt or other suitable method. The use of extrusion methods is particularly useful in preparing granules of consistent performance and release characteristics.

In one set of embodiments the granular fertiliser composition comprises granules having a core matrix comprising a mixture of the fertiliser active, silicate mineral and ionic polyurethane and further comprises a coating about the matrix for providing additional control of release of the fertiliser active from the granular composition. The granular fertiliser composition may be prepared in a flowable matrix and granulated with a coating material such as a natural or synthetic biodegradable polymer. In one set of embodiments a matrix comprising a mixture of the fertiliser, silicate mineral and ionic polyurethane dispersion is formed into granules by extrusion and optionally coated with a biodegradable polymer coating.

The coating typically comprises at least one biodegradable polymer selected from the group consisting of aliphatic polyesters, polyanhydrides, polycarbonates, polyurethanes comprising aliphatic polyester segments, polyureas comprising aliphatic polyester segments, copolymers of two or more thereof and mixtures thereof wherein the coating.

Examples of the synthetic biodegradable polymer s are disclosed in “Polymeric Biomaterials” ed. Severian Dumitriu, ISBN 0-8247-8969-5, Publ. Marcel Dekker, New York, USA, 1994. Synthetic biodegradable polymers include polyesters, such as for example, polylactic acid), poly(glycolic acid), copolymers of lactic and glycolic acid, copolymers of lactic and glycolic acid with polyethylene glycol), poly(e-caprolactone), poly(3-hydroxybutyrate), poly(p-dioxanone), polypropylene fumarate); as described by Heller in: ACS Symposium Series 567, 292-305, 1994; Polyanhydrides including poly(sebacic anhydride) (PSA), poly[bis(p-carboxyphenoxy)propane)anhydride]) (PCPP), poly[bis (p-carboxyphenoxy) methane] (PCPM), poly[bis(p-carboxyphenoxy)hexane] (PCPH) and copolymers of two or more of sebacic anhydride (SA), (p-carboxyphenoxy)propane (CPP) and (p-carboxyphenoxy) methane (CPM), as described by Tamada and Langer in Journal of Biomaterials Science—Polymer Edition, 3, 315-353,1992 and by Domb in Chapter 8 of the Handbook of Biodegradable Polymers, ed. Domb A. J. and Wiseman R. M., Harwood Academic Publishers.

The preferred biodegradable polymers are polyesters, particularly aliphatic polyesters. Examples of preferred polyesters include for example, polylactic acid), poly(glycolic acid), copolymers of lactic and glycolic acid, copolymers of lactic and glycolic acid with poly(ethylene glycol), poly(e-caprolactone), poly(3-hydroxybutyrate), polyp-dioxanone), polypropylene fumarate) Poly (ortho esters) including Polyolidiketene acetals addition polymers such as described by Heller in: ACS Symposium Series 567, 292-305, 1994; Polyanhydrides including poly(sebacic anhydride) (PSA), poly(carboxybisbarboxyphenoxyphenoxyhexane) (PCPP), poly[bis (p-carboxyphenoxy) methane] (PCPM), copolymers of SA, CPP and CPM, such as described by Tamada and Langer in Journal of Biomaterials Science—Polymer Edition, 3, 315-353,1992 and by Domb in Chapter 8 of the Handbook of Biodegradable Polymers, ed. Domb A. J. and Wiseman R. M., Harwood

In a preferred set of embodiments the biodegradable polymer coating is a polymer having at least a polymeric segment selected from the group consisting of polylactic acid (PLA), poly(glycolic acid), polycaprolactone (PCL), polyvalerolactone, poly(hydroxyl valerate), poly(ethylene succinate), poly(butylene succinate), poly(butylenesuccinateadipate), poly(para-dioxanone), polydecalactone, poly(4-hydroxybutyrate), poly(beta-malic acid) and poly(hydroxyl valerate). The polymer may be a polyurethane or polyurea comprising such groups or in a preferred set of embodiments comprises the aliphatic polyester polymer or blend of such polymers.

In a particularly preferred embodiment the biodegradable polymer coating is a caprolactone polymer which may be a homopolymer of caprolactone or a copolymer such as a block copolymer of poly(l-lactic acid) and poly ε-caprolactone. In a further embodiment the biodegradable polymer may be formed from corresponding poly(ester-urethane)s such as a polyurethane comprising polyester dials such as the caprolactone or a copolymer such as a block copolymer of poly(l-lactic acid) and poly ε-caprolactone. In the most preferred embodiment, the biodegradable polymer is a polycaprlactone or caprolactone copolymer, particularly a polycaprolactone polylactic acid block copolymer, which is prepared by reactive extrusion in the process of forming the polymer tube.

The biodegradable polymer is preferably formed of biodegradable polyester polymer having a molecular weight (Mn) of at least 20,000, preferably at least 30,000 and most preferably at least 50,000. Polycaprolatone homopolymers and copolymers, such as copolymers with an acid monomer, particularly poly-L-lactic acid, having a molecular weight (Mn) of at least 20,000, preferably at least 30,000 and most preferably at least 50,000 are most preferred. In the more preferred embodiments the tube is formed of a polymer selected from the group consisting of polylactic acid, poly(glycolic acid), polycaprolactone, polyvalerolactone, poly(hydroxyl valerate), polyethylene succinate), polybutylene succinate), poly(butylenesuccinateadipate), poly(para-dioxanone), polydecalactone, poly(4-hydroxybutyrate), poly(beta-malic acid), poly(hydroxyl valerate), polycaprolactone copolymers with polylactic acid and mixtures of two or more of these polymers.

In addition to the biodegradable polymer the coating may, if desired, further comprise a polymer selected from the group of polyolefins, polyvinyls and mixtures thereof in an amount of no more than 50% by weight of the coating and generally no more than 50% w/w of the polymeric component of the coating. In combination with the biodegradable coating these polymers provide useful delay and yet on biodegradation of the above biodegradable polymers allow permeation of the active following delay after placement of the granular composition in soil. Degradation of the biodegradable polymers allows polyolefins and polyvinyls to be more effectively degradable in soil.

The biodegradable polymer coating most preferably comprises at least one selected from the group consisting of polylactic acid, polycaprolactone, lactic acid caprolactone copolymers and mixtures thereof.

The biodegradable polymer coating may be applied to the matrix by any suitable coating method such as extrusion coating, tumble coating, granulation, spray coating and the like. Many suitable coating methods are known in the art and may be practised by those skilled in the art, having regard to the teaching herein without undue experimentation.

The coating in one set of embodiments provides a thickness of no more than 500 microns, preferably no more than 300 microns. In one set of embodiments the coating is at least 10 microns. In a preferred set of embodiments the matrix is extrusion coated. The matrix in a preferred set of embodiments is coated by forming a tube of the coating material.

In one set of embodiments the coating comprises of the no more than 15% by weight of the granular composition, preferably no more than 10% by weight of the granular composition.

a particularly preferred embodiment of the granules of the controlled release fertiliser composition comprise;
a core matrix comprising a mixture of urea, a silicate mineral which is a clay and a polymer which is a biodegradable ionic polyurethane comprising polyester diol segments such as polycaprolactone diol and ionic groups such as BMPA; and
a coating about the core matrix comprising at least one polyester selected from the group consisting of polylactic acid, poly(glycolic acid), polycaprolactone, polyvalerolactone, poly(hydroxyl valerate), poly(ethylene succinate), polybutylene succinate), poly(butylenesuccinateadipate), poly(para-dioxanone), polydecalactone, poly(4-hydroxybutyrate), poly(beta-malic acid) poly(hydroxyl valerate) and copolymers thereof, more preferably the extruded tube is formed of a polycaprolactone or copolymer thereof with polylactic acid.

It is preferred that the molecular weight (Mn) of the polymer coating is at least 20,000. more preferably at least 50,000. In the pelletised composition the extruded tube of biodegradable polymer preferably comprises from 1% to 10% by weight of the weight of the granular composition.

In one set of embodiments the granular controlled release fertiliser provides release of at least 80% of the agrichernical active after a period of delayed of at least one month from placement in contact with soil. The preferred range of wall thickness to achieve delayed release with biodegradable polyesters such as PCL and PCL-PLA is typically in the range of from 10 microns to 300 microns but will depend on the specific polymer composition and molecular weight of the components. In one set of embodiments the polymer coating is of thickness in the range of from 10 microns to 100 mmicrons such as from 20 microns to 70 microns. Such polymers may be prepared by ring opening polymerisation in a reactive extrusion process.

Surprisingly we have also found that a Lewis acid catalyst may be used to control the rate of degradation of a biodegradable polymer such as PCL or PCL-PLA. It is known to use metal and non-metal catalysts in preparation of polycaprolactone and other polyester biodegradable polymers. We have found, however, that the level of Lewis acid catalyst has a significant effect on the rate of degradation of the polymer coating and that this finding can be used to control the rate of release of the fertiliser when placed in soil. Accordingly the biodegradable polymer composition comprises a Lewis acid in an amount sufficient to enhance the degradation of the polymer. The amount of Lewis acid may be used to determine the period of delay prior to release of the agrichemical and also the rate of release. Higher concentration of the Lewis acid will facilitate shorter periods of delay while lowed concentration provides longer periods of delay prior to release.

The amount of Lewis acid may thus be determined having regard to the delay required prior to release of the agrichemical active. In a preferred set of embodiments the biodegradable polymer is selected from aliphatic polyester, polycarbonate and polyanhydrides. The amount of Lewis acid catalyst is preferably at least 0.05% (such as 0.05% to 1% or 0.05% to 0.5%) by weight based on the weight of polymer, preferably at least 0.1% by weight and more preferably in the rage of from 0.1 to 1% by weight based on the weight of biodegradable polymer and more preferably from 0.1 to 0.5% by weight based on the weight of biodegradable polymer. Examples of suitable Lewis acid catalysts include those based on metals selected from Cu²⁺, Zn²⁺, Ti²⁺, Sn²⁺ and the like which may be in the form of simple salts such as sulfates or chlorides or organometalics such as aluminium isopropoxide, titanium tetrabutoxide, tin octanoate. Preferred Lewis acids may be selected from the group consisting of titanium dioxide, titanium chloride, aluminium isopropoxide, aluminium halide, tin dioxide and montmorrilonite. In one set of embodiments the coating of the granular controlled release agrichemical comprises a Lewis acid selected from the group consisting of metal oxides and metal alkoxides.

In one set of embodiments the Lewis acid is selected from the group consisting of titanium dioxide, titanium chloride, aluminium isopropoxide, aluminium halide and tin dioxide.

The granular controlled release fertiliser composition may comprise a coating which coats at least part of the matrix and may extend about at least a part of a core of the matrix comprising the fertiliser active, silicate mineral and ionic polyurethane. The granules may be in the form of cylindrical pellets or prills or the form of particles which are rounded or approximately spherical. In one embodiment the coating of biodegradable polymer extends about cylindrical or short rod shaped granules and the ends of the cylindrical or short rod shaped granules may be uncoated or may also be coated.

The coating may comprise the biodegradable polymer or consist entirely of the biodegradable polymer. In one set of embodiments the biodegradable polymer comprises at least 50% by weight of the coating, such as at least 60% by weight or at least 70% by weight of the coating.

The biodegradable coating may comprise one or more filler materials which may be used to modify the rate of degradation of the pellets by providing pores or greater water permeability to provide access of water from the soil to the core matrix following placement of the pellet in soil. Non-limiting examples of fillers include mineral and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, or any cellulose containing material). The amount of filler in the composition may vary depending upon the polymeric matrix and the desired physical properties of the finished composition. In one set of embodiments the coating of the granular controlled release agrichemical composition comprises an inorganic filler, preferably a silicate mineral filler, present in an amount of up to 30% by weight of the coating.

In one embodiment the coating is carried out by a process which comprises:
extruding a tube of coating composition comprising the biodegradable polymer and Lewis acid;
inserting within the tube a plurality of longitudinally spaced portions of a core matrix comprising the active; and
sealing the tube between the longitudinally spaced portions to form pellets comprising portions of core matrix.

The extrusion of the tube may use conventional extrusion equipment.

It is generally preferred that the core matrix is intermittently inserted into the tube during the process of extrusion of the tube. For example, in one set of embodiments the core matrix is intermittently extruded within the tube. The equipment used may be any suitable equipment known in the art for coextrusion. The appropriate condition for extrusion will depend on the consistency and composition of the core matrix. In many embodiments the core matrix is of a paste consistency which may be readily extruded. In other embodiments the core matrix comprises a polymeric material which may be a thermoplastic or thermoset and facilitate coextrusion, for example as a thermoplastic or thermoset composition of the core matrix.

The process of sealing the tube may be carried out in a number of ways. In one set of embodiments the step of sealing the tube comprises collapsing the tube between portions of core matrix. The collapsing process may be carried out by one or more blades applying pressure to the side of the tube while in a relatively plastic state. A plurality of opposed blades may apply a force to the outside of the tube to collapse it between portions of core matrix. This step may produce separation of individual pellets or separation may be carried at a later step or even by the end user.

In another set of embodiments the process comprises intermittently inserting portions of a barrier resin material such as a wax, polymer or the like between portions of matrix and cutting through the tube and barrier material between portions of core matrix. The resulting pellets have a peripheral wall of tube polymer and end walls of barrier material with the core matrix portions encased within. The tube, in this embodiment may form a seal with the barrier resin. The barrier resin used in forming the ends of the pellets may be the same or different from the tube polymer. For example a different porosity or biodegradability of the barrier resin compared with the polymer tube may be used to control the delay in exposure of the core matrix to the environment in use, such as when placed in soil.

In a preferred embodiment the matrix comprises a mixture of urea, a silicate mineral and a biodegradable ionic polyurethane polymer. In this embodiment an extrusion process may be used in coating the matrix comprising:
extruding a tube of coating composition comprising biodegradable thermoplastic polymer comprising polyester segments and Lewis acid;
inserting within the tube a plurality of longitudinally spaced portions of the matrix; and
sealing the tube between the longitudinally spaced portions of the matrix to form discrete pellets comprising portions of the matrix.

### BRIEF DESCRIPTION OF THE DRAWINGS

Specific embodiments of the invention are descried with reference to the attached drawings

In the drawings:

FIG. 1 is a graph showing the degradation profile, presented as GPC Molecular weight distribution curves, for blank samples of Example 1 with varying catalyst loadings, soaked in water after five weeks as described in Example 3.

FIG. 2 is a graph showing the influence of humidity level applied using a controlled chamber on the molecular weight (Mp) of compositions of Example 1 with differing amounts of catalyst in accordance with the test protocol of Example 3.

FIG. 3 includes two column charts (3a and 3b) showing the molecular weight (Mn in left column Mw in right hand column) for PLA-PCL films with different amounts of catalyst after exposure for one month (FIG. 3a) and two months (FIG. 3b) in accordance with the testing protocol described in Example 4.

FIG. 4 includes two column charts (4a and 4b) showing the effect of different Lewis acid catalysts on the hydrolytic degradation of films of PCL-PLLA after 44 days in accordance with Example 5. FIG. 4a showing molecular weight and FIG. 4b showing polydispersity against a polystyrene standard.

FIG. 5 includes two column charts (5a and 5b) showing the effect of different amounts of the Lewis acid aluminium isopropoxide on the hydrolytic degradation of films of PCL-PLLA after 44 days in accordance with Example 6.

FIG. 6 shows the testing assembly used to assess urea release from extruded biodegradable polymer containing different Lewis acid catalyst loadings.

FIG. 7 is a graph showing the urea transport across a range of membranes compositions of thickness 120 microns at 22° C., 35° C. and 50° C..

FIG. 8 is a graph showing the variation of urea transport with time across a 160 micron membrane of a composition containing 70% PLLA 30% PCL with 0.5% w/w catalyst (three left hand side plots) and without catalyst (three right hand side plots).

FIG. 9 is a graph of variation of urea transport across polymer membranes with time for three membranes with 70PLLA3OPLC of 160 micron thickness and no catalyst (upper three plots) and 70PLLA3OPCL with 200 micron thickness (lower two plots).

FIG. 10 is a schematic longitudinal section showing an extruder for coextrusion of nutrient matrix within a continuous polymer tube.

FIG. 11 shows a schematic longitudinal section showing intermediates in preparing pellets of one embodiment of FIG. 11 including (a) the tube containing spaced nutrient matrix segments, (b) segment of tube cut between discrete nutrient matrix portions and (c) completed pellets in which ends of cut tube segments are closed so that the tube polymer envelops the nutrient matrix.

FIG. 12 is a longitudinal cross section of one embodiment of a pellet formed in accordance with the invention.

FIG. 13 shows a schematic longitudinal section showing intermediates in preparation of pellets of an alternative process in which alternating polymer and nutrient matrix portions are coextruded within the tube (a) and tube is cut between spaced nutrient portions and through polymer portions to provide a tube of polymer having and outer tube, central nutrient matrix within the tube and ends of the tube sealed with polymer (b).

FIG. 14 is a graph showing the percentage of urea lost with time from urea prills coated with PCL as described in Example 13.

FIG. 15 includes two graphs showing the change in molecular weight of PCL-PLLA films containing different amounts of aluminium isopropoxide catalyst from day 0 to day 31 of placement in clay-loam soil. FIG. 15(a) shows change in Mn and FIG. 15 (b) shows change in Mp,

FIG. 16 is a graph showing the average molecular weight (Mw) of PC film of samples numbers 3, 4 and 5 referred to in Example 23 initially and after 10, 35 and 55 days of being buried in wet tropical soil.

FIG. 17 is a graph showing the average molecular weight (Mn) of PCL film of samples numbers 3, 4 and 5 referred to in Example 23 initially and after 10, 35 and 55 days of being buried in wet tropical soil.

FIG. 18 is a graph showing the polydispersity (PD) of PCL. film of samples numbers 3, 4 and 5 referred to in Example 23 initially and after 10, 35 and 55 days of being buried in wet tropical soil,

FIG. 19 is a graph showing the molecular weight (Mn and Mw) and polydispersity (PD) of granules of Sample number 1 of Example 23 initially and after 10, 35 and 55 days of being buried in wet tropical soil.

FIG. 20 is a graph showing the molecular weight (Mn and Mw) and polydispersity (PD) of granules of Sample number 2 of Example 23 initially and after and after 10, 35 and 55 days of being buried in wet tropical soil.

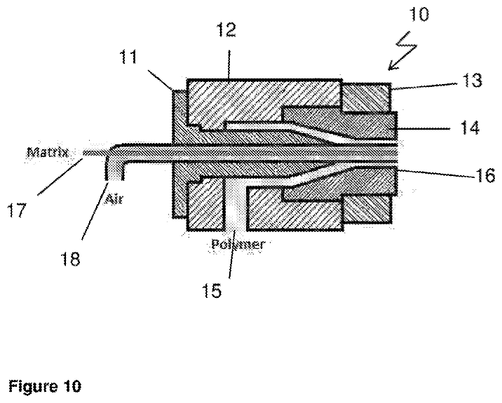

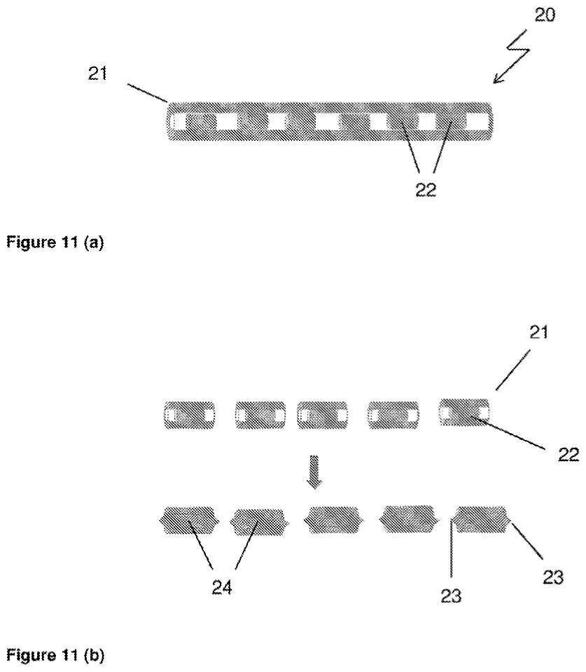

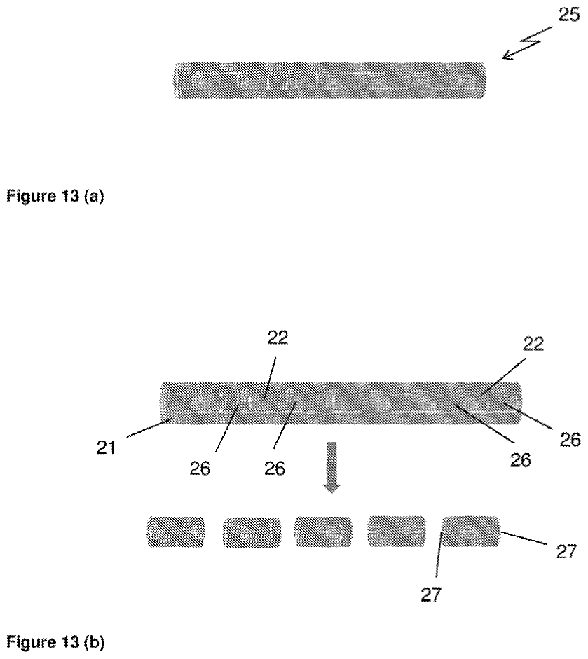

In one embodiment of the process the pellets are formed by coextrusion of a thermoplastic tube, such as formed of a polycaprolactone-polylactic acid copolymer, with spaced portions of a core matrix, such as a paste comprising a urea composition, clay and ionic polyurethane. Referring to FIG. 10 there is shown a longitudinal section of a coextruder (10) for coextrusion to form of an intermediate coextruded structure (FIG. 11a) from which individual pellets may be formed (FIG. 11b). The coextruder comprises a number of interlocking parts (11-14) providing tube resin inlet (15) for feeding polymer tube resin under pressure to an annular extrusion port (16) and a matrix extrusion channel (17) in which discrete portions of matrix may be conveyed in a sleeve (18) of air. In one embodiment the portions of matrix may be separated by a resin for forming the ends of the pellets as shown in FIG. 13.

Referring to FIG. 11 (a) there is shown the intermediate structure (20) comprising a length of an outer tube (21) of the thermoplastic such as polycaprolactone-polylactic acid copolymer, with coextruded spaced portions of a core matrix (22).

Referring to FIG. 11 (b) the individual pellets may be formed by cutting the tube between portions (22) of matrix and collapsing the tube (21) to form ends (23) of pellets (24) formed of the tube polymer. This operation may be performed in separate steps as shown in FIG. 11 or the separation of the pellets may be carried out in a process step in which the tube is collapsed between portions of matrix and cut in a process continuous with the collapsing action, for example using opposed blades.

Referring to FIGS. 13 (a) and 13 (b) an alternative process in shown in which the length of coextruded structure (25) comprises a length of tube (21), spaced portions of matrix (22) and portions of resin (26) between portions of matrix (FIG. 13(a)). The tube is cut through portions of the resin (26) to separate the pellets and provide pellet ends (27) formed of the resin (FIG. 13(b)).

The invention will now be described with reference to the following examples. It is to be understood that the examples are provided by way of illustration of the invention and that they are in no way limiting to the scope of the invention.

### EXAMPLES

Method

Particle size was measured by Wyatt Dyna. Pro Plate Reader Wyatt Technology Corporation, 6300 Hollister Ave, Santa Barbara, Calif. 93117-3253. The viscosity of polymer solution was measured by Brookfield digital rotary viscometer, model 94800-0.

Tetrahydrofuran (THF) was used as eluent and solvent in GPC measurements, using WATERS 2695 Separations module, WATERS 2414 Refractive Index, four PLGel columns (3×5 m MIXED-C AND 1×3 M Mixed-E) in a series with flow 1.0 mL/min. Molecular weight was determined according to calibration on polystyrene standards.

DSC was performed on a Mettler Toledo DSC821 using samples (˜5 mg weight) at a heating rate of 10° C./min under nitrogen purge The samples were stored for 48 h under a vacuum at room temperature (RT) (0.1 Torr) prior to analysis. Tensile testing was performed on an Instron Model 4468 universal testing machine following the ASTM D 882-02 test method at ambient temperature (23° C.) with a humidity of around 54%.

The 1H-NMR, 130 NMR and COSY techniques were used for the characterization of polymer structure. 1H-NMR spectra were recorded on Bruker Advance II Spectrometer, Germany operating at 400 MHz. 13 C NMR and COSY spectroscopic measurements were performed with 500 MHz in all NMR analyses CDCl₃ was used as solvent.

Fourier transform infrared (FTIR) spectra were collected on a Perkin Elmer Spectrum 2000 FTIR instrument in attenuated total reflectance (ATR) mode using diamond as the background reference. The infrared data were recorded in wavenumbers (cm⁻¹) with the intensity of the absorption (vmax) specified as either strong (s), medium (m), weak (w) and prefixed broad (b) where appropriate.

Biodegradation Test Method for Film

Assessment of the rate of degradation of the test samples exposed to soil or compost was carried out under simulated test conditions, by measuring the amount of carbon dioxide evolved from bioreactors containing the test samples. The theoretical amount of carbon dioxide THCO₂, in grams per bioreactor, which the test material can produce was calculated using following equation:

THCO₂=MTOT×CTOT×44/12 where, MTOT is the total dry solids, in grams, in the test material at the start of the test, CTOT is the proportion of total organic carbon in the total dry solids in the test material, in grams per gram, 44 and 12 are the molecular mass of carbon dioxide and the atomic mass of carbon, respectively. From the cumulative amounts of carbon dioxide released, calculate the percentage biodegradation Dt, of the test materials for each measurement interval using following equation:

Dt=((CO₂)T−(CO2) B/THCO₂)×100

where, (CO₂) T is the cumulative amount of carbon dioxide evolved in each bioreactor containing test material, in grams per bioreactor. Solvent cast samples of films containing the polymer were prepared.

Biodegradation Test in Soil in Field Condition

Solvent cast samples of films PCL films containing varying concentrations of catalyst were hot melt pressed into 0.3 mm thick sheets at 120° C. Samples of ˜1 g (film) placed in ‘regular pantyhose’ having, an internal support frame made of PC tubing. 11 cm diameter, 1 cm high with 0.4 cm thick walls. Free ends of the pantyhose were sealed with cable ties. The complete arrangement was then buried in sandy loam soil at a depth of approximately 10 cm. M.Wt. determinations were made at regular interval.

Measurement of Rates of Fertiliser Release from Polymer Coated Matrix and Pellets

The laboratory methods use incubation to determine either the time taken until a specified amount of nutrient is released (e.g. time for 75% release) or the amount released over a specified time (Carson and Azores-Hampton, 2012). For the commercial, tubular, granular CRF sample (0.3 to 0.4 g) was mixed with 10 g of acid-washed fine sand and transferred to a 10 ml syringe. For coated urea pellets, 8 pellets weighing 0.4-0.6 g were used. A disc of fibreglass glass filter paper (Whatman GF/C) was placed at the bottom of the syringe to prevent loss of sand and clogging. Another disc was placed on top of the sand to distribute input solution across the surface.

A leaching solution of 2 mM CaCl₂ was applied at the rate of 50 mL daily to the centre at the top of the columns using multichannel peristaltic pumps. Leaching was collected by gravity and measured by weight initially twice daily and then at ˜24 h intervals. Measurements were carried out in triplicate and in an incubation set at

The laboratory method also included extruded with active urea core were placed in sealed pill bottles containing water. This assembly was then placed in a constant temperature oven until the water was sampled for urea in solution. Multiple pill bottles were uses so a range of time intervals could be investigated. Detection of urea in water solution was carried out by UV-VIS spectroscopy using a colourant (p-dimethylaminobenzaldehyde) to activated the urea. A calibration cure is first constructed to yield a ppm vs absorbance level at 420 nm. For those concentration falling outside the calibration limits, dilutions of the original solution are made accordingly.

Reference: Spectrophotometric Method for Detection of Urea. G. W. Watt and J.D. Chrisp. Analytical Chemistry. Vol: 26, No. 3. March 1954. pp 452-453.

Materials

Natural latex rubber (Water emulsified, “Sprayable Latex” with 40.2% solids content was received from Barnes, Sydney. Sodium Alginate was received as powder from Melbourne Food Depot, Victoria, Polyurethanes—As synthesised. Bentonite clay was received from Aldrich and used as received. Commercial PLA was supplied by NatureWorks (PLA 7000D) from Cargill-Dow UK with. Monomer Epsilon—caprolactone (99%) obtain from Fluka, was used. Monobutyltin oxide (BuSnOOH) was use as catalyst, provided from Arkema Inc, Philadelphia. Polymer Polycaprolactone (PCL) was purchased from Solvay, England. Carbon black HIBBLACK® 890 was purchased from Korea Carbon Black Co Ltd and used as received.

Abbreviation

PCL=Polycaprolactone polymer
PLLA=Poly-Tactic acid polymer

### PU=Polyurethanes

### Example 1

### Biodegradable Polymer Synthesis and Composition: PCL-PLLA Copolymer Synthesis

Granules of PLA were ground and dried for two hours in nitrogen own at 100° C. before use. The -caprolactone was dried on oil bath at temperature 100° C. under vacuum pump. Synthesis of copolymer with ε-caprolactone 15 and 20% by weight were prepared as follows:

PCL-PLLA polymer was synthesized by ring opening polymerisation using reactive extrusion.

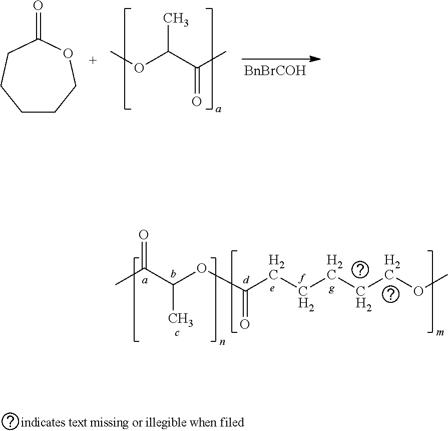

### Synthesis Scheme of PCL-PLLA Polymer

The actual polymerization time (depending on the amount of catalyst added and the temperature conditions used) varies between two hours and up to two days. It has to be noted that the limitation in finalizing the polymerization is the time needed for the remaining monomer to diffuse through the already formed high viscous polymer in order to reach the reactive sites. The polymer obtained with such a process often has a low thermal stability in melt processing. The polymerization time was in this case two hours for samples as well for blanks.

The kinetics of bulk polymerization of PLA with ε-caprolactone in the presence of BuOSn as catalyst was studied with 0.08, 0.05, 0.03, 0.01 and 0.005% w/w catalyst and results are summarised in Table 1.

The results show that samples with different amount of catalyst after two hours of reaction have lower molecular weight than starting material PLA 7000D. Peak molecular weight of starting polymer PLA measure by GPC was 187661 with polydispersity (PDI) of 1.6 and melt flow index (MR) at 210° C. of 7.5. After two hours the molecular weight is lower and the polymer has a PDI value of 1.8.

Increasing catalyst levels lowers the molecular weight of resultant polymers and a lower amount of monomer (ε-caprolactone) in reactions will result in lower molecular weight in comparison with the use of higher amounts of monomer in reactions.

TABLE 1
Mn, Mp and polydispersity (PDI) value for non-processes
samples from bulk reactors after two hours of synthesis.

| | | | | |
|---|---|---|---|---|
| ε - caprolactone | Catalyst | | | |
| [%] | [%] | Mn | Mp | PDI |

SAMPLES

| | | | | |
|---|---|---|---|---|
| 20% | 0.08 | 33911 | 66798 | 1.8 |
| | 0.05 | 42683 | 82130 | 1.77 |
| | 0.03 | 51530 | 93459 | 1.78 |
| | 0.01 | 55145 | 97769 | 1.77 |
| | 0.005 | 59295 | 104536 | 1.83 |
| 15% | 0.08 | 25553 | 48871 | 1.9 |
| | 0.05 | 37957 | 76119 | 1.82 |
| | 0.03 | 46532 | 89490 | 1.8 |
| | 0.01 | 51615 | 93528 | 1.8 |
| | 0.005 | 51755 | 100155 | 1.9 |

BLENDS

| | | | |
|---|---|---|---|
| PLA7000D | 110249 | 165743 | 1.8 |
| PLA7000D + 0.08% fascat | 66070 | 113309 | 1.8 |
| PLA7000D + CAPPA 6800 | 79511 | 119685 | 1.7 |
| PLA7000D + 15% ε-caproloctone | 78630 | 128159 | 1.84 |
| PLA7000D + 20% ε-caproloctone | 75644 | 129635 | 1.9 |
| PLA7000D + 50% ε-caproloctone | 106919 | 135991 | 1.51 |
| PLC | 76047 | 114381 | 1.63 |
| ε-caproloetone + 0.08% catalyst | 27671 | 59038 | 2.09 |

### Example 2

### Synthesis of PCL-PLLA Polymer Blend by Extrusion

PCL and PLLA blends were prepared by extrusion process using granules of both PCL and PLLA polymers with different loading of the catalyst BuOSn in amounts of 0.5, 1, 1.5, 2 and 3% by weight of the polymer respectively. PCLPLLA polymers were compounded at temperatures between 160-190° C. by using a Haake twin screw extruder. The extruded blends were pelletized into pellets in order to feed to the extrusion of films process. PCL/PLA blends were feed into the hopper of a film extrusion process with temperature profile 160-180° C. Three films of thickness 120, 160 and 200 micron were prepared.

### Example 3

### Hydrolytic Degradation of PCL-PLLA Co-Polymer

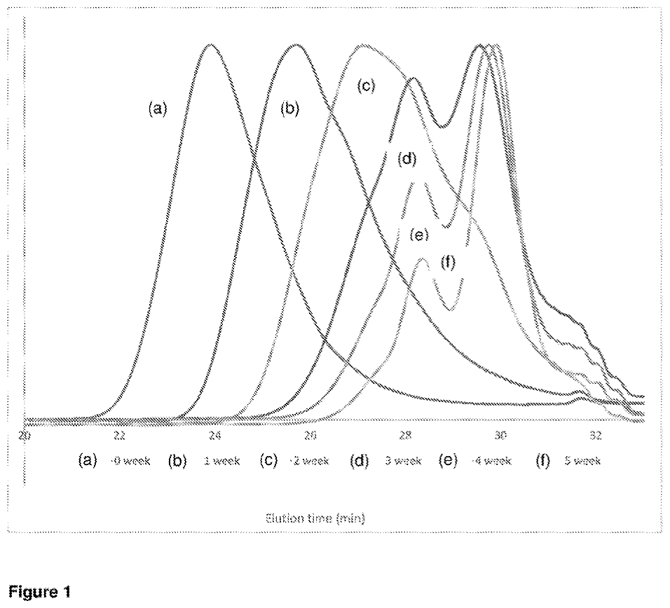

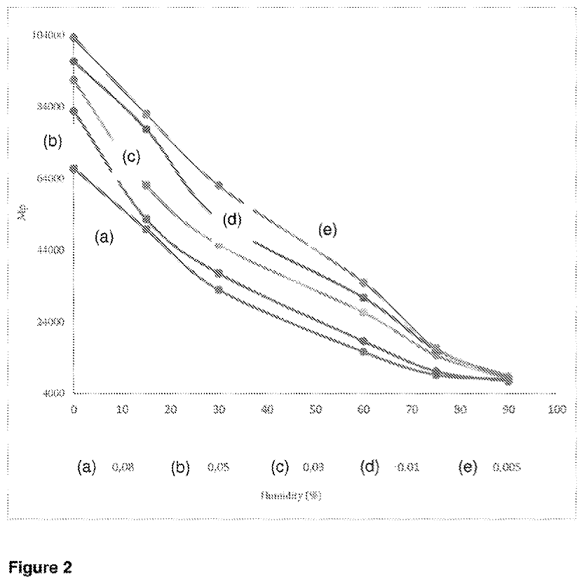

The films prepared with different amount of catalyst in Example 1 were soaked in water at ambient temperature and showed various degradation profile shown in FIGS. 1 and 2.

FIG. 1 shows the GPC Molecular weight distribution curves for the blank soaked in water after five weeks. Samples with increasing amount of c-caprolactone and lower level of catalyst have higher Mp than those synthesized with higher amount of catalyst.

FIG. 2 shows Influence of increasing humidity on degradation of samples and blends in controlled chamber.

### Example 4

### Hydrolytic Degradation of PCL-PLLA Blend Film

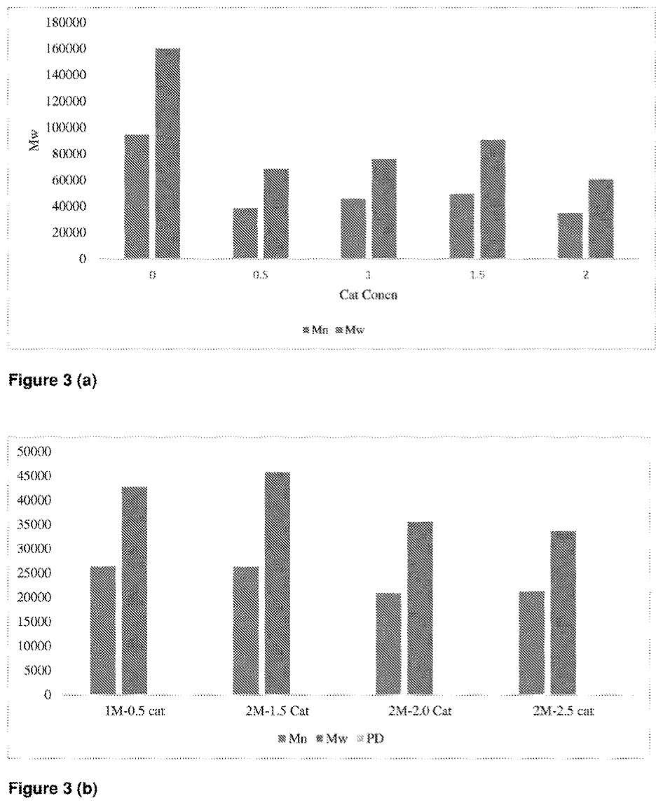

Strips of the film composition prepared in Example 2 with different levels of tin catalyst were subject to degradation by immersion in distilled water (20.0 g) sealed in a glass vile and places in bench top oven at 50° C. Samples were removed at 2 month interval, dried and 5-10 mg of polymer was dissolved in a small 2 vial with N,N-Dimethylacetamide (DMAC) and placed in a 50° C. oven for several hours until fully dissolved. This solution was filtered through 40 μm syringe filter into 1 mL gel permeation chromatography (GPC) vial with rubber septum. The degradation profile of the films are summarised in in FIG. 3 which showed polymer degradation was dependent on catalyst concentration.

FIG. 3 shows the hydrolytic degradation of PLA-PCL films with varying amounts (% w/w) of Sn catalyst after a) 1, and b) 2 months. The number average molecular weight (g/mole) is determined against a polystyrene standard.

### Example 5

### Hydrolytic Degradation of PCL-PLLA Blend Film Containing Different Catalysts

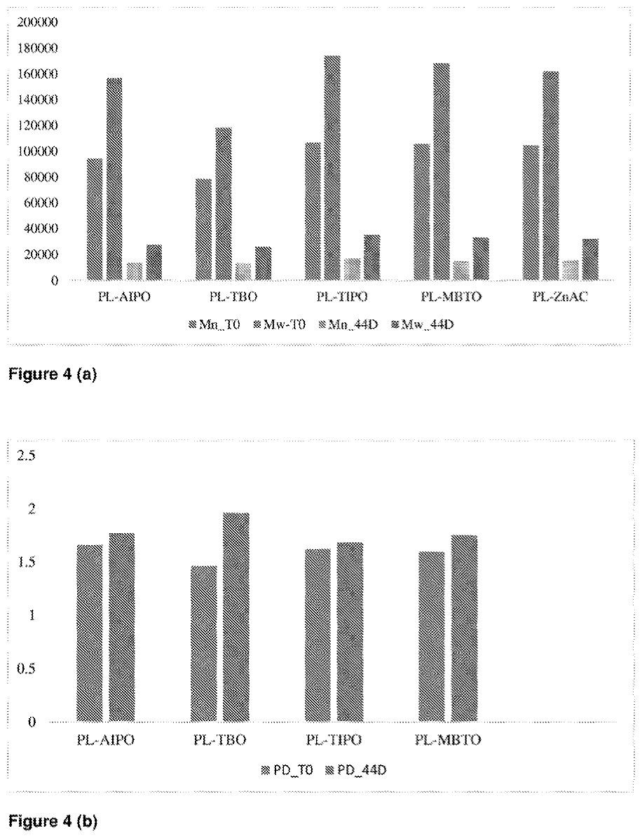

Five different PCL-PLLA copolymers were prepared using 0.5 wt % of different catalyst Aluminium isopropoxide (AIPO), Titanium butoxide (TBO), Titanium isopropoxide (TIPO). Monobutyltin oxide (MBTO) and Zinc acetate (ZnAc) following the procedure described in Example 1. The samples were each compressed moulded into thin films and evaluated in hydrolytic degradation tests as described in Example 4. All polymer samples showed significant reduction in molecular weight after 44 days and are results summarised in Table 2 and FIGS. 4 (a) and 4 (b). In each group of columns in FIG. 4(a) the columns from left to right in the group show Mn at time 0 (Mn_T0), Mw at time 0 (Mw_T0), Mn at 44 days (Mn_44D) and Mw at 44 days (Mw_44D).

TABLE 2
PCL-PLLA degradation profile with different catalyst

| | | Time ‘1’ = |
|---|---|---|
| CATALYST | TIME ‘0’ | 44 days |
| PL-AlPO Aluminium | 94095/156830/1.66 | 13531/27367/1.77 |
| isopropoxide | | |
| PL-TBO-Titanium butoxide | 78652/118265/1.46 | 13050/25662/1.96 |
| PL-TIPO-Titanium | 106839/173887/1.62 | 16524/35089/1.68 |
| isopropoxide: | | |
| PL-MBTO -Monobutyltin oxide | 105387/167996/1.59 | 14602/33116/1.75 |
| PL-ZnAc Zinc acetate | 104674/161903/1.54 | 15109/31975/2.11 |

FIG. 4 shows the hydrolytic degradation of PLA-PCL films with varying catalyst after 44 days a). Number average molecular weight Mn- and weight average molecular weight (Mw) (g/mole) b) Polydispersity (PD) against a polystyrene standard at time 0 (PD_T0) and at 44 days (PD_T0).

### Example 6

### Hydrolytic Degradation of PCL PLLA Blend Film Containing Different Concetration of Aluminium Isopropoxide (AIPO)

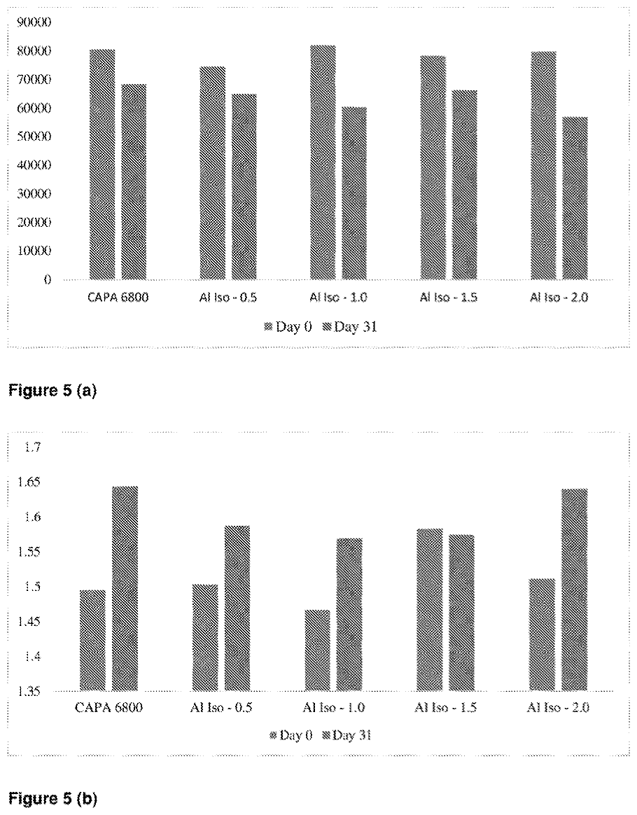

PCL-PLLA copolymers containing five different concentration of Aluminium isopropoxide (AIPO), were prepared following the general procedure described in Example 1. The samples were compress moulded into thin films and hydrolytic degradation was evaluated in accordance with tests described in Example 4. The polymer showed significant reduction in molecular weight in all samples containing different amount of catalyst after 31 days and results are summarised in FIG. 5.

FIG. 5: Hydrolytic degradation of PLA-PCL films with different concentration of catalyst Aluminium isopropoxide (ALISO in FIG. 5 (a) and (b)) after 0 days in the left hand column of each pair and 31 days in the right hand column of each pair of columns. FIG. 5(a) compares molecular weight (Mn-) and FIG. 5(b) compares polydispersity (PD).

### Example 7

### Urea Permeation Across PLLA-PCL Membranes

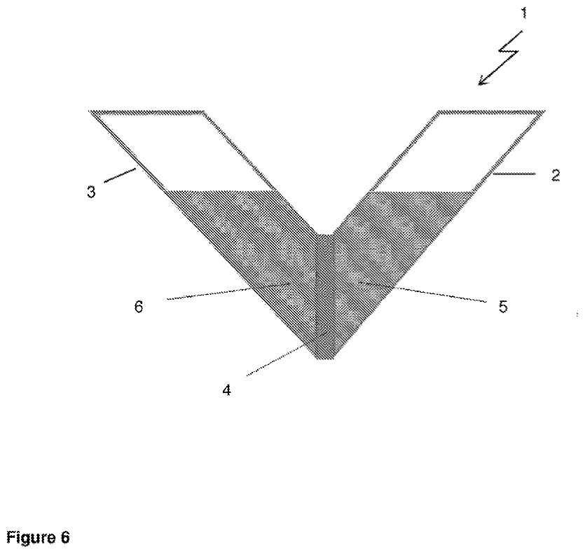

A series of PLLA-PCL (90:10 wt ratio or 70:30 wt ratio) prepared in Example 2 with different loading of catalysts were evaluated as membranes for urea release. The rate of urea transport across the films was measured as a function of time. The films were placed within the testing assembly shown schematically in FIG. 6. Referring to FIG. 6 the testing assembly (1) includes two inclined tube sections (2,3) separated by a membrane (4) in a “V” configuration with urea solution (5) in a tube section (2) on one side of the membrane (4) and distilled water (6) in the tube section (3) on the other side of the membrane from the urea solution (5).

The method used is as follows:

### Step Process

1. Prepare a solution of urea (1080 g/L).
2. Select an area of film with no/minimal defects and cut roughly 62 mm diameter segment and place in test jig of FIG. 6.
3. Add 30 mL of urea solution to one side and 30 ml of DI water to the other side.
4. Plug opening to each side with a rubber stopper to prevent evaporation.
5. Record date and time.
6. Sample at regular intervals determine the transport across the membrane.

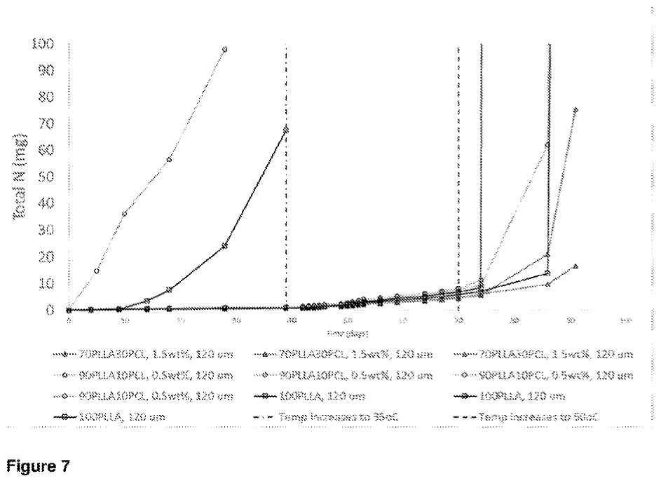

The release profiles of urea are summarised in FIGS. 7-9.

FIG. 7 shows urea transport across membranes at 22° C., 35° C. and 50° C..

FIG. 7 demonstrates that PLLA-PCL films with a thickness of 120 μm allow minimal transport of urea across the film at ambient (22° C.) temperature. Once increased to 35° C. (see dashed line at 40 days) there was a systematic increase in the rate of urea transport across the films. After 70 days total testing, the temperature was increased to 50° C., resulting in considerable increase in urea transport across the film and more rapid breakdown or failure of the films. Urea transport across membranes at 54° C. showing that addition of catalyst leads to the early onset of film degradation and decrease of ‘zero release’ period.

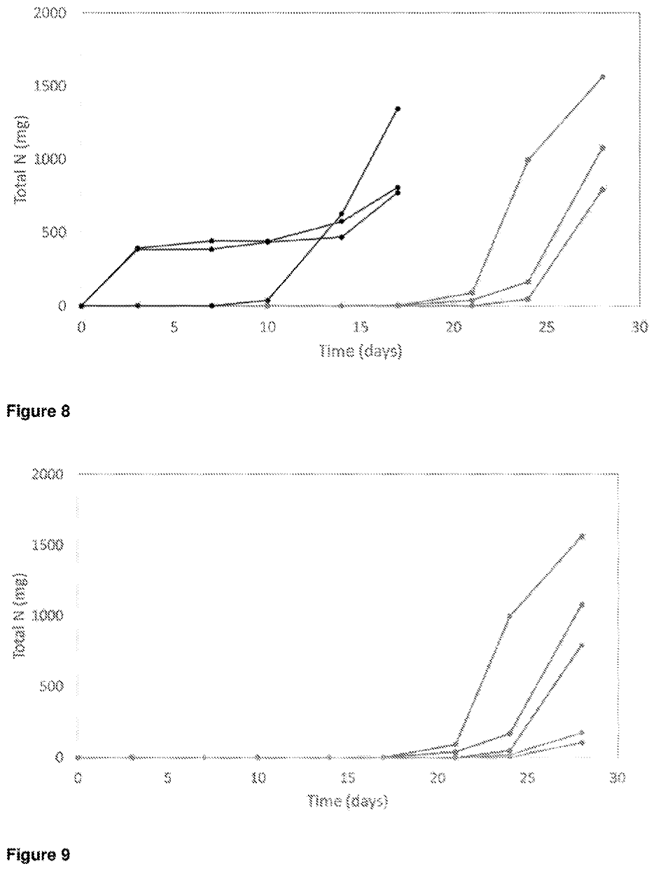

Subsequent testing has been carried out at 50° C. FIG. 8 shows urea transport across 160 μm thick films with the addition of 0.5 wt % monobutyltin oxide (BuOSn) catalyst (three left hand side plots) and without the addition of 0.5 wt % monobutyltin oxide (BuOSn) catalyst (three right hand side plots).

FIG. 9 shows the impact of increasing thickness of the film on urea transport rates. The results for urea transport across membranes at 50° C. show that increased thickness of the coating leads to a slightly increased ‘zero release’ period and slower rate of transition to total failure of the coating.

### Example 8

### Polymer Coated Matrix: Co-Extrusion of Urea Matrix with PCL Polymer

Ureatentonite clay matrix as prepared in Example 16 is flowable at ambient temperature. The slurry coextruded into polymer tube successfully using low molecular weight polycaprolaotone (PCL) (Mn- 68,000 Da) polymer in varying ratios 1:2, 1:1 and 2:1 of slurry: PCL (FIG. 10) and then pelletized manually.

The co-extrusion of the filled polymer tubing was carried out with an annular extrusion die (Guilt Tool & Engineering Co., Guilt 812 crosshead) using three feeds. A 16 mm co-rotating screw extruder (Prism Eurolab 16) fitted with a gear-driven melt pump (Barrell) delivering the molten polymer for the outer layer, compressed air to keep the internal aperture open and control wall thickness and the nutrient matrix which was delivered via a syringe protruding through the extrusion die into the forming tube supplied by a piston pump (Teledynelsco 500D).

The tubing, was cooled either with air or by passing through a water bath and taken off with a conveyor belt. The tubing wall thickness and overall diameter was varied by altering the polymer feed rate, melt temperature, nutrient matrix feed rate, air flow and haul off rate.

Example extruder conditions; Extruder temp profile 20-90° C. die temp 110° C., screw speed 120 rpm, polymer feed rate 45%, melt pump 20%, nutrient feed rate 2 mL/min.

In formulations used to co-extrude with PLA/PCL polymers, only bentonite clay and urea solution were used to prepare the matrix. Formulation being 1:5.4; of bentonite:50% urea/water solution,

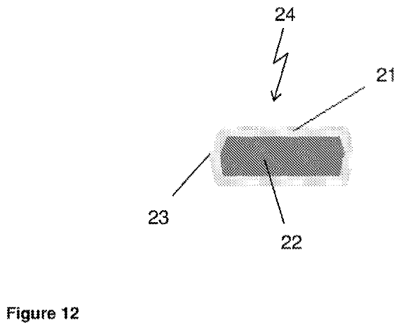

Co-extrusion of urea with PCL polymer may be conducted in accordance with the scheme shown in FIGS. 11 (a) and 11 (b) to provide pellets shown in FIG. 12.

### Example 9

### Co-Extrusion Processes

In an alternative process to that shown in FIG. 11 and FIG. 12 the urea could be coextruded with biodegradable polymer using the pellet co-extrusion process shown in FIGS. 13(a) and 13(b) in which portions of a resin are coextruded into the tube between the urea to provide pellet ends by cutting the extrusion through portion of the resin between portions of urea.

### Example 10

### Urea Matrix: Urea-Bentonite Clay Matrix Composition

### Method 1

Commercial urea prills (Richgro®) were prepared to a 50% (wt/wt) solution with water. This was spatulated with bentonite clay 20 wt % until a thick, homogeneous paste was made. To this a biodegradable polyurethane emulsion (of Example 11) was also incorporated in the final formulation by spatulation.

Method 2

Commercial urea prills (Richgroe) were prepared to a 50% (wt/wt) solution with water. This was spatulated with bentonite clay 20 wt % (as the sodium salt, high AR grade) and 1 wt % hydroxyethyl cellulose until a thick, homogeneous paste was made. Ta this a biodegradable polyurethane emulsion prepared according to Example 11 was also incorporated in the final formulation by spatulation. The final composition of the Gore matrix composition is shown in Table 3 below.

### Method 3

Commercial urea prilis (Richgro®) were prepared to a 50% (wt/wt) solution with water. This was spatulated with bentonite clay 20 wt % (as the sodium salt, high AR grade) and 1 wt % hydroxyethyl cellulose until a thick, homogeneous paste was made. To this a biodegradable polyurethane emulsion of Example 11 was also incorporated in the final formulation by spatulation and extruded as a solid component through a pressurised syringe pump and thrown into water bath containing calcium chloride solution (5 wt %) to crosslink the polyurethane polymer.

### Method 4

Commercial urea prilis (Richgroe) were prepared to a 50% (wt/wt) solution with water. This was spatulated with bentonite clay (as the sodium salt, high AR grade) until a thick, homogeneous paste was made. To this composition a biodegradable polyurethane emulsion was also incorporated by spatulation. The resulting matrix paste was then sprayed with calcium chloride 2-5 wt % solution to crosslink the biodegradable polyurethane polymer.

TABLE 3
Core matrix composition

| | Component |
|---|---|
| Component | Percentage |
| Bentonite Clay | 25 |
| Urea/water solution (50% wt/wt) | 51 |
| Biodegradable ionic polyurethane (BPU) of Example 11 | 11 |
| Water | 13 |

The above matrix formulation of bentonite-urea-BPU-water was extruded (by syringe) into 2% CaCl₂ solution to provide crosslinked polyurethane. The matrix was dried at 90° C. for under nitrogen for 72 h.

Incorporation of polyurethane in the matrix composition provides a hydrophobic coating on the matrix and hinders easy access to water to hydrolytically sensitive matrix and slow down the release of urea. The ionic crosslinking of polyurethane film with CaCl₂ solution will further improve the hydrolytic stability, biodegradation and mechanical integrity to thermosets polyurethane film.

### Example 11

### Polymer Formulation

A biodegradable ionic polyurethane was prepared by two step solution polymerisation methods in water. Following precursors were used in the polymer.

PCL (MW 1000, 20.00 g), IPDI (8.20 g), BMPA (0.432g), TEAe (0.309 g), EDA (0.774 g Polyol and pre-dried BMPA (0.43g). The mixture was accurately weighed into a three neck flask equipped with mechanical stirrer, dropping funnel and nitrogen inlet. The mixture was heated with stirring to 100° C. for one hour until all BPM dissolved. The reaction temperature was lowered to 90° C. and IPDI (8.20 g) was added to the above polyol mixture and reacted for another 4 h at the 90° C. The flask was cooled down to 60° C. and anhydrous Triethylamine (0.309g) was added and reaction continued for 30 mins. The flask was further cooled down to 0° C. using an ice bath. Deionised water (44.0 ml) containing 2 wt % SDDS was quickly added to this pre-cooled prepolymer mixture and was stirred vigorously to yield an emulsified opaque solution. Chain extension agent EDA (0.76 g) was added drop wise to this solution and stirring continued for 30 mins. The reaction flask was later warmed to 25° C. and the stirring continued until NCO peak disappeared. The low viscous stable aqueous dispersion of polyurethanes thus obtained was stored in an air tight container at ambient temperature.

The polymer showed an average particle size distribution of 425±53 nm with a viscosity of 625 mPa.s. The molecular weight of polymer was Mₙ=74961, M_{w}=226290 and PD=3.01.

### Example 12

### Urea Release from Urea/Bentonite Clay Matrix at Room Temperature

The bentonite-urea-BPU matrix prepared in Example 10, 3.31 g was placed in a sintered glass crucible (No 1 porosity) on a plinth allowing the crucible to be surrounded by water (600 mL) at RT. Total available urea in the oven dried matrix was 0.78 g or 1400 ppm in the body of water. Ultraviolet (UV) light spectroscopy was used to determine the amount of urea released into a body of water over a period of time (see Table 2). The results showed almost 54% loss in 4 days. The concentration exceed the calibration curve accuracy after this time period.

TABLE 4
Concentration of urea leached form oven dried matrix formulation.

| Time | Concentration of released urea |
|---|---|
| (h) | (ppm) |
| 6 | None Detected |
| 24 | None Detected |
| 48 | 240 |
| 72 | 618 |
| 96 (4 D) | 760 |

### Example 13

### Urea Release from Low Mw PCL Coated Urea Prill

Urea prills (average weight 22 mg) were rolled and coated in molten PCL (MW. 10K) at 100-150° C. The coated prill was then dropped into cold water from approximately 12 m height. Prills were retrieved from the water and patted dry with tissue paper. A single coated prill was then placed in 25.00 mL of water in a sealed pill bottle and left at room temperature until tested. Testing was carried out by calibrated UV-VIS interpolation by taking 2.00 mL of immersion water made up to 15 mL followed by a colourant of p-dimethylaminobenzaldehyde for free urea in water. The test showed the loss of 100% urea in 8 days. A coating with a mixture of different MWs of PCL in different ratios is also achieved using above method to control the release of urea from the coating.

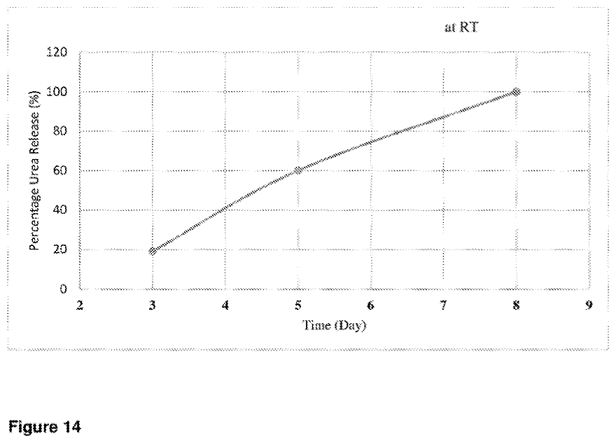

FIG. 14: shows the urea percentage loss from urea prill coated with PCL 10,000 dalton at room temperature.

### Example 14

### Urea Release from Extruded PCL Polymer Tube Filled with Urea Matrix at Different Temperatures

Hot melt sealed tablets were prepared by method given in Example 6 using PCL polymer 6800 with no catalyst. The hot sealed tablets were tested prior to the test by squeezing to make sure the matrix did not move within the extruded tablet. Four single pellet (average 0.13 g)) was placed in 25.00 mL water sealed in a pill bottle. This was placed in a constant temp oven at 50° C. A 2 mL sample of this water was then taken at regular time intervals For UV-VIS analysis for free urea in solution. The table shows mg of free urea lost (from a possible 22 mg contained in the pellet). There are some inconsistencies in free urea detection, likely from the contamination during pellet preparation, however, after 69 days there was only a trace loss from all tablets (Table 5).

The same samples were also subjected to different temperature at 60 and 75° C. The samples at 75° C. degrade overnight while sample in oven at 60° C. released only 11 mg (25.36%) in 49 days. The results are summarised in table.

TABLE 5
Urea % loss from extruded PCL polymer coated urea matrix

| | | | Urea Release |
|---|---|---|---|
| Sample | Days | Temperature | (ppm) |
| PCL-Matrix | 69 | 25 | 2 (1%) |
| PCL-Matrix | 1 | 75 | 45 (100%) |
| PCL-Matrix | 49 | 60 | 11 (25.36%) |

### Example 15

### Urea Release from Extruded PCL Polymer Containing BuOSn Catalyst Tube Filled with Urea Matrix

Hot melt sealed tablets were prepared by method given in Example 6 using PCL polymer 6800 with 0.5 wt % catalyst. The hot sealed tablets were tested prior to the test by squeezing to make sure the matrix did not move within the extruded tablet. Four single pellet (average 0.13 g)) was placed in 25.00 mL water sealed in a pill bottle. This was placed in a constant temp oven at 50° C. A 2 mL sample of this water was then taken at regular time intervals for UV-VIS analysis for free urea in solution. The table shows mg of free urea lost (from a possible 135 mg contained in the pellet).

TABLE 6
Urea % loss from extruded PCL polymer g BuOSn
catalyst tube filled with urea matrix.

| | | | Urea Release |
|---|---|---|---|
| Sample | Days | Temperature | (ppm) |
| PCL-Matrix | 42 | 50 | 29 ppm (21%) |

### Example 16

### Degradation of PCL-PLLA Films with and Without Catalyst Films in Soil

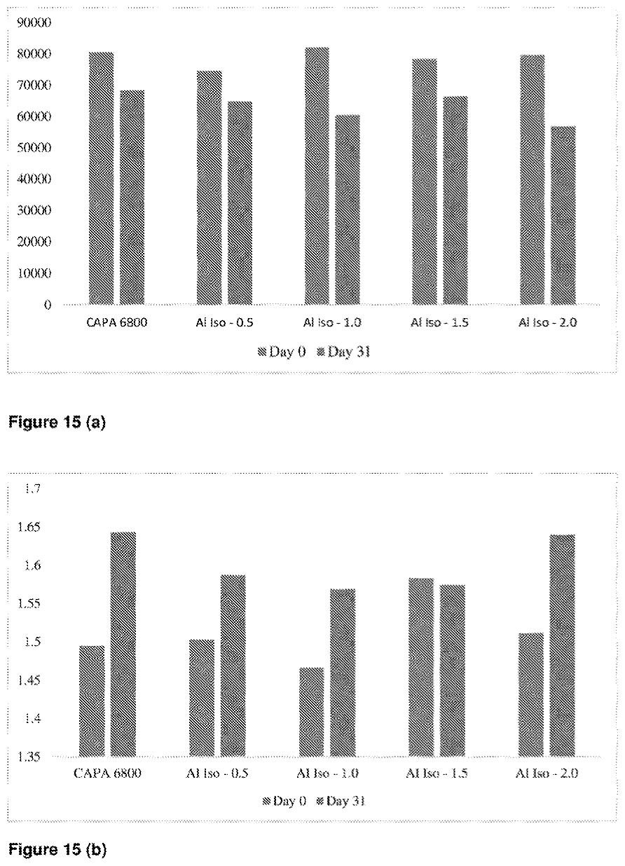

Degradation of PCL-PLLA films containing different concentration of Aluminium isopropoxide (AIPO), was carried out using strips of polymer film in clay loam soil in field conditions. Polymer degradation was monitored by GPC and results are shown in FIG. 15.

FIG. 15 shows CPC results of polymer samples from soil test after 0 days (left hand column in each group) and 31 days (right hand column in each group) where FIG. 15 a) shows the number average molecular weights (Mn-) and in FIG. 15 (b) the polydispersity (PD) is shown).

### Example 17

### Urea Coating with Thermoplastic Polymers

A small, 4 L bowl, tablet coater was used to coat commercial urea prills. 30.0 g of urea prills were rotated in the bowl so as to cause the body of prills to ‘cascade’ within the bowl in a continuous motion. At this point, an air brush paint spray was used to direct a fine spray of coating agent onto the main body of the cascading prills. A two part coating was used. Firstly, water dispersible PU prepared in example 11 was sprayed at 10% solids content onto the urea prills with gently heating provided by an air gun until a loading of approximately 3% was gained. The coated prills were placed in an oven at 50t over night, replaced in the tablet coater and sprayed with ‘shellac’ (1 part in 4 of ethanol) aided with gentle heating. Coating continued until a weight gain of approximately 3% was made.

Degradable and bio-degradable polymers such as alginate, carbomethoxy cellulose, hydroethoxy cellulose, shellac, slack wax was used as a primer or as an outer layer to polyurethane and their loading to 3 to 30%, to optimise nutrient release profile.

### Example 18

### Urea Coating with Thermoplastic Polymers Containing Carbon Black

A small, 4 L bowl, tablet coater was used to coat commercial urea prills, 30.0 g of urea prills were rotated in the bowl so as to cause the body of prills to ‘cascade’ within the bowl in a continuous motion. At this point, an air brush paint spray was used to direct a fine spray of coating agent onto the main body of the cascading prills. A two part coating was used. Firstly, water dispersible PU prepared in example 11 containing 2 wt % carbon black (HIBBLACK® 890) was sprayed at 10% solids content onto the urea prills with gently heating provided by an air gun until a loading of approximately 3%% was gained. The coated prilis were placed in an oven at 50° C. over night, replaced in the tablet coater and sprayed with ‘shellac’ (1 part in 4 of ethanol) aided with gentle healing. Coating continued until a weight gain of approximately 3% was made.

### Example 19

### Urea Coating with Crosslinked Polymers

A small, 4 L bowl, tablet coater was used to coat commercial urea prills. 30.0 g of urea prills were rotated in the bowl so as to cause the body of prills to ‘cascade’ within the bowl in a continuous motion. At this point, an air brush paint spray was used to direct a fine spray of coating agent onto the main body of the cascading prills. A two part coating was used. Firstly, PU prepared in example 11 was sprayed at 10% solids content onto the urea mills with gently heating provided by an air gun until a loading of approximately 3% was gained. The coated urea prills was then sprayed with 5% solution of calcium chloride with gently heating by an air gun. The coated prills were placed in an oven at 50° C. over night, replaced in the tablet coater and sprayed with ‘shellac’ (1 part in 4 of ethanol) aided with gentle heating. Coating continued until a weight gain of approximately 3 to 10% was made.

### Example 20

### Urea Coating with Schellac

A small, 4 L bowl, tablet coater was used to coat commercial urea prills, 30.0 g of urea prills were rotated in the bowl so as to cause the body of prills to ‘cascade’ within the bowl in a continuous motion. At this point, an air brush paint spray was used to direct a fine spray of coating agent onto the main body of the cascading prills. The coated prills was sprayed with ‘shellac’ (1 part in 4 of ethanol) aided with gentle heating. Coating continued until a weight gain of approximately 3 to 30% was made.

### Example 21

### Urea Coating with Non-Ionic Polyurethane

A small, 4 L bowl, tablet coater was used to coat commercial urea wills. 30.0 g of urea prills were rotated in the bowl so as to cause the body of pills to ‘cascade’ within the bowl in a continuous motion. At this point, an air brush paint spray was used to direct a fine spray of coating agent onto the main body of the cascading prills. The coated prills was sprayed with ‘shellac’ (1 part in 4 of ethanol) aided with gentle heating followed by non-ionic polyurethane formulation of example 11 dissolved in THF. Coating continued until a weight gain of approximately 3 to 30% was made.

### Example 22

### Urea Release from Coated Tablet

The coated urea tablet prepared in example 16, was placed in a vial containing water and left overnight at ambient temperature. The coating failure was measured by counting the number of floated samples. The urea coated sample in example 16 showed 50% failure over a period of 3 days.

Detection of urea in water solution was carried out by UV-VIS spectroscopy using a colourant (p-dimethylaminobenzaldehyde) to activated the urea. A calibration cure is first constructed to yield a ppm vs absorbance level at 420 nm. For those concentration falling outside the calibration limits, dilutions of the original solution are made accordingly (Reference; Spectrophotometric Method for Detection of Urea. G. W. Watt and J. D. Chrisp. Analytical Chemistry. Vol; 26, No. 3, March 1954. pp 452-453).

### Example 23

### PCL Degradation and Urea Release from PCL Coated Urea in Field Conditions

Samples of the coated fertiliser and biodegradable film listed in Table 7 were subjected to field trials in sugarcane fields in three different locations within the wet tropics. In the trials, plastic mesh bags each having a number of separate pouches were used to retain samples of coated urea pellets and polymer film strips and were buried to examine degradation in tropical conditions.

TABLE 7

| Sample No | Description |
|---|---|
| 1 | coated fertilisers granules of Example 15 |
| 2 | Coated fertiliser of Example 19 |
| 3 | Example 5 PCL film with no Catalyst (TBO) |
| 4 | Example 5 PCL film with 0.05 wt % catalyst (TBO) |
| 5 | Example 5 PCL film with 0.5 wt % catalyst (TBO) |

PCL strips were of dimensions 6 cm×1 cm and thickness of approximately 0.5 mm

The mesh bags were retrieved at regular interval and the results up to 55 days are summarized below. The retrieved samples were analysed by GPC for their number average molecular weight and polydispersity. The control sample included only polymer strip placed in the same bag.

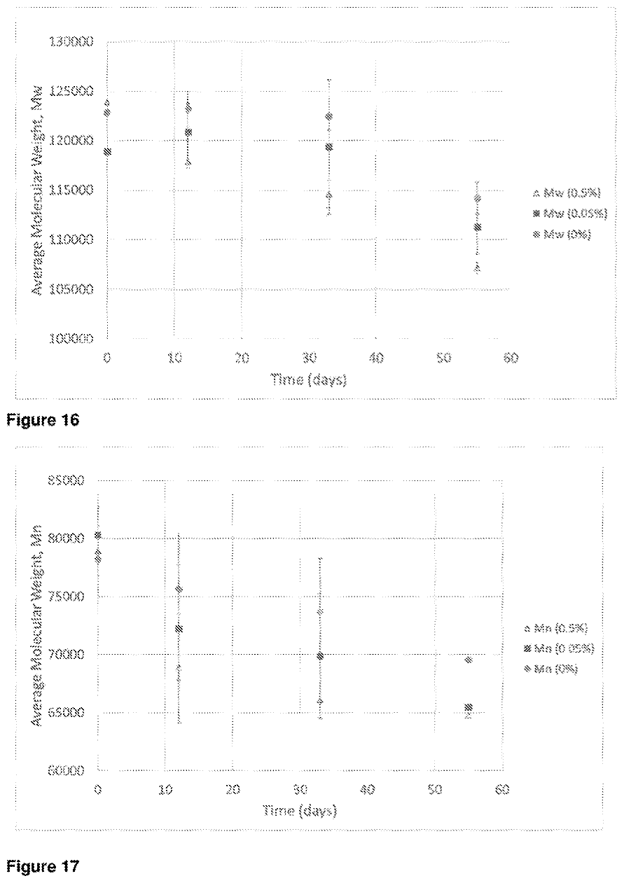

FIG. 16 is a graph showing the average molecular weight (Mw) of PC film of samples numbers 3, 4 and 5 referred to in Example 23 initially and after 10, 35 and 55 days of being buried in wet tropical soil.

FIG. 17 is a graph showing the average molecular weight (Mn) of PCL film of samples numbers 3, 4 and 5 referred to in Example 23 initially and after 10, 35 and 55 days of being buried in wet tropical soil.

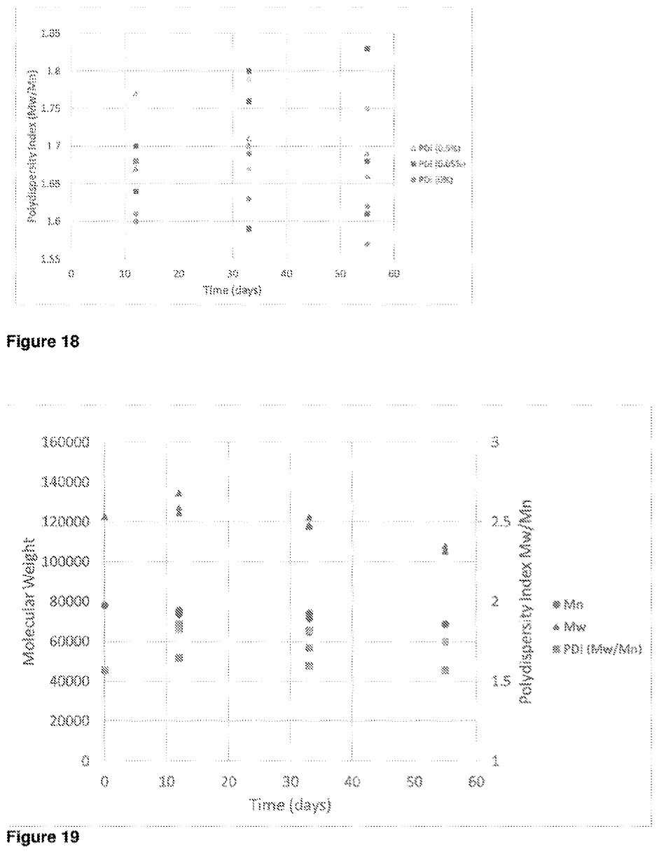

FIG. 18 is a graph showing the polydispersity (PD) of PCL film of samples numbers 3.4 and 5 referred to in Example 23 initially and after 10, 35 and 55 days of being buried in wet tropical soil.

FIG. 19 is a graph showing the molecular weight (Mn and Mw) and polydispersity (PD) of granules of Sample number 1 of Example 23 initially and after 10, 35 and 55 days of being buried in wet tropical soil.

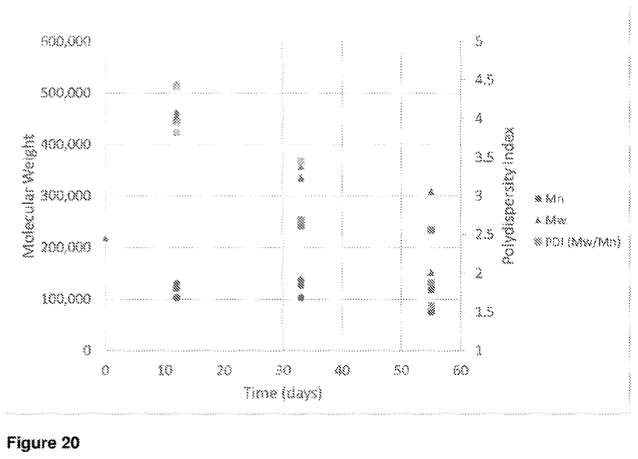

FIG. 20 is a graph showing the molecular weight (Mn and Mw) and polydispersity (PD) of granules of Sample number 2 of Example 23 initially and after and after 10, 35 and 55 days of being buried in wet tropical soil.

1. A controlled release granular fertiliser composition comprising a mixture of nitrogenous fertiliser, particulate silicate mineral filler and biodegradable ionic polyurethane.

2. (canceled)

3. A controlled release granular fertiliser composition according to claim 1, wherein the silicate mineral is selected from the group consisting of bentonite, attapulgite and montmorillonite.

4. A controlled release granular fertiliser composition according to claim 1, wherein the biodegradable ionic polyurethane comprises ionic groups selected from the group consisting of carboxylate, sulfonate and ammonium,

5. A controlled release granular fertiliser composition according to claim 1, wherein the biodegradable ionic polyurethane comprises the reaction product of (a) a diisocyanate; and (b) at least one active hydrogen containing compound and wherein at least one active hydrogen containing compound comprises an ionic or ionisable group which provides ionic groups on neutralisation.

6. A controlled release granular fertiliser composition according to claim 1, wherein the biodegradable ionic polyurethane comprises a polyol prepolymer of molecular weight of 500-5000.

7. A controlled release granular fertiliser composition according to claim 6, wherein the prepolymer is chain extended with a primary or secondary amine having at least two active hydrogens and which may be quaternised to provide cationic groups.

8. A controlled release granular fertiliser composition according to claim 1, wherein the biodegradable ionic polyurethane comprises a plurality of ionic groups derived from monomers independently selected from the group consisting of 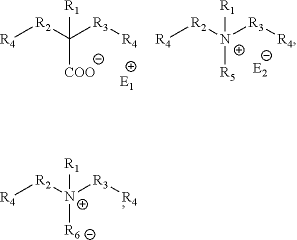
and mixtures thereof, where;
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; R₅ is selected from the group consisting, of hydrogen, alkyl groups of 1 to 18 carbon atoms; acyl groups and aralkyl groups;
R₆ is selected from the group consisting of carboxylates, sulfonates and phosphonates;
E₁ is a counter-ion that is organic or inorganic; and
E₂ is a counter-ion that is organic or inorganic.

9. A controlled release granular fertiliser composition according to claim 1, wherein the ionic groups of the biodegradable ionic polyurethane are provided by one or more monomers selected from the group consisting of 2,2- bis(hydroxymethyl) propionic acid (BMPA), tartaric acid, dimethylol butanoic acid (DMBA), glycollic acid, thioglycollic acid, lactic acid, malic acid, dihydroxy malic acid, dihydroxy tartaric acid, and 2,6-dihydroxy benzoic acid and neutralisation of the resulting polymer with a tertiary amine.

10. A controlled release granular fertiliser composition according to claim 1, wherein the biodegradable ionic polyurethane comprises a polyester monomer segment selected from the group consisting of polylactic acid, poly(glycolic acid), polycaprolactono, polyvalerolactone poly(hydroxyl valerate), poly(ethylene succinate), poly(butylene succinate), poly(butylenesuccinateadipate), poly(para-dioxanone), polydecalactone, poly(4-hydroxybutyrate), poly(beta-malic acid) and poly(hydroxyl valerate).

11. A controlled release granular fertiliser composition according to claim 10, wherein the biodegradable ionic polyurethane comprises polyester monomer segment selected from polycaprolactone, polylactic acid and a mixture thereof or copolymer thereof.

12. A controlled release granular fertiliser composition according to claim 1, wherein the biodegradable ionic polyurethane is cross linked by a cross linker selected from the group consisting of divalent, and trivalent metal cations.

13. A controlled release granular fertiliser composition according to claim 1, wherein the nitrogenous fertiliser is at, least 30% by weight of the controlled release granular fertiliser wherein the weights are based ort dry weight.

14. A controlled release granular fertiliser composition according to claim 1, wherein the dry weight ratio of nitrogenous fertiliser to silicate mineral is in the range of from 5:1 to 1:5.

15. A controlled release granular fertiliser composition according to claim 1, wherein the biodegradable ionic polyurethane is present in an amount of at least 5% by weight of the dry weight of the controlled release granular fertiliser composition.

16. A controlled release granular fertiliser composition according to claim 1, wherein the composition comprises an intimate mixture comprising:
from 20% to 70% w/w of nitrogenous fertiliser;
from 10% to 60% w/w of silicate mineral; and
from 5% to 60% w/w biodegradable ionic polyurethane;
wherein the weights are based on dry weight of the composition.

17. (canceled)

18. A controlled release fertiliser composition according to claim 1, comprising water in an amount of from 10% to 40% of the composition.

19. A controlled release granular fertiliser composition according to claim 1, further comprising a coating of a barrier material about granules of the composition.

20. (canceled)

21. A controlled release granular fertiliser composition according to claim 19 wherein the barrier coating comprises a biodegradable polymer comprises at least one polyester selected from the group consisting of polylactic acid, poly(glycolic acid), polycaprolactone, polyvalerolactone, poly(hydroxyl valerate), poly(ethylene succinate), poly(butylene succinate), poly(butylenesuccinateadipate), poly(para-dioxanone), polydecalactone, poly(4-hydroxybutyrate), poly(beta-malic acid) and poly(hydroxyl valerate).

22. (canceled)

73. (canceled)

24. A controlled release granular fertiliser composition according to claim 19, wherein the barrier coating polymer has a molecular weight (Mn) of at least 10,000.

25. (canceled)

26. A process for preparing a granular fertiliser composition according to comprising:
forming an aqueous mixture comprising nitrogenous fertiliser, silicate mineral and ionic biodegradable ionic polyurethane and granulating the aqueous composition to provide granules of nitrogenous fertiliser.

27. (canceled)

28. (canceled)

29. (canceled)
